(19) United States
(12) Patent Application Publication
(10) Pub. No.: US 2012/0259539 A1
(43) Pub. Date: Oct. 11, 2012

(54) Navigation Device and Guiding Method Thereof

(75) Inventor: Akio Sumizawa, Kanagawa (JP)

(73) Assignee: Clarion Co., Ltd., Saitama-shi, Saitama (JP)

(21) Appl. No.: 13/517,160

(22) PCT Filed: Dec. 27, 2010
(86) PCT No.: PCT/JP2010/073612

§ 371 Date: Jun. 19, 2012

(30) Foreign Application Priority Data
Dec. 28, 2009 (JP) 2009-298079
Dec. 28, 2009 (JP) 2009-298080

(51) Int. Cl. G01C 21/26

(52) U.S. Cl. 701/400

(57) ABSTRACT

Disclosed is a navigation device capable of guiding HOV lanes more intelligibly. The device comprises a storage unit that stores installation information relating to traffic lanes that become passable when predetermined conditions are satisfied (hereinafter referred to as “conditional traffic lanes”) and a guiding unit that guides entrances to the conditional traffic lanes. The guiding unit displays entrance guide images for guiding the car in which the device is installed to the entrances to the conditional traffic lanes instead of images that have been displayed until then when the position of the car approaches the entrances to the conditional traffic lanes.

### TECHNICAL FIELD

The present invention relates to a navigation device and a guiding method employed in the navigation device. The present invention claims priority from Japanese Patent Application No. 2009-298079 filed on Dec. 28, 2009 and Japanese Patent Application No. 2009-298080 filed on Dec. 28, 2009, the contents of which are incorporated by reference herein in those designated states that allow incorporation by reference of literature.

### BACKGROUND ART

Conventionally, in a navigation device, there has been used a technology of searching for routes corresponding to traffic lanes in which only vehicles satisfying specific conditions are qualified for traveling, such as high-occupancy vehicles (HOV) lanes. Patent Literature 1 describes a technology for such navigation device. Note that, the HOV lanes are also called “car pool lanes”.

### CITATION LIST

### Patent Literature

[PTL 1] JP 2000-131085 A

### SUMMARY OF INVENTION

### Technical Problem

However, in the conventional navigation device, guidance as to the HOV lanes is not necessarily provided at a satisfactory level.

In view of the above, the present invention has an object of providing guidance as to HOV lanes more intelligibly in a navigation device.

### Solution To Problem

In order to solve the above-mentioned problem, according to an aspect of the present invention (hereinafter, referred to as “first aspect of the present invention”), there is provided a navigation device which aims at providing guidance as to an HOV lane by visually displaying the HOV lane in a visually apparent manner, comprising: storage unit adapted to store lane assignment information of a traffic lane (hereinafter, referred to as “conditional lane”) that is available for passage of vehicles when a predetermined condition is satisfied; and guiding unit adapted to provide guidance as to an entrance of the conditional lane. When an own vehicle position is appeared to come closer to the entrance of the conditional lane, the guiding unit displays an entrance guidance image for guiding the vehicle to the entrance of the conditional lane instead of a previously displayed image. Further, according to another aspect of the present invention (hereinafter, referred to as “second aspect of the present invention”) there is provided a navigation device which determines at higher accuracy whether or not a certain lane is an HOV lane, comprising: storage unit adapted to store lane information containing a lane assignment time period of a traffic lane (hereinafter, referred to as “conditional lane”) that is available for passage of vehicles when a predetermined condition is satisfied; and guiding unit adapted to provide guidance as to an entrance of the conditional lane. The guiding unit uses the lane information to identify a road which is designated as the conditional lane at a predetermined time, and provides the guidance as to the entrance of the identified road designated as the conditional lane.

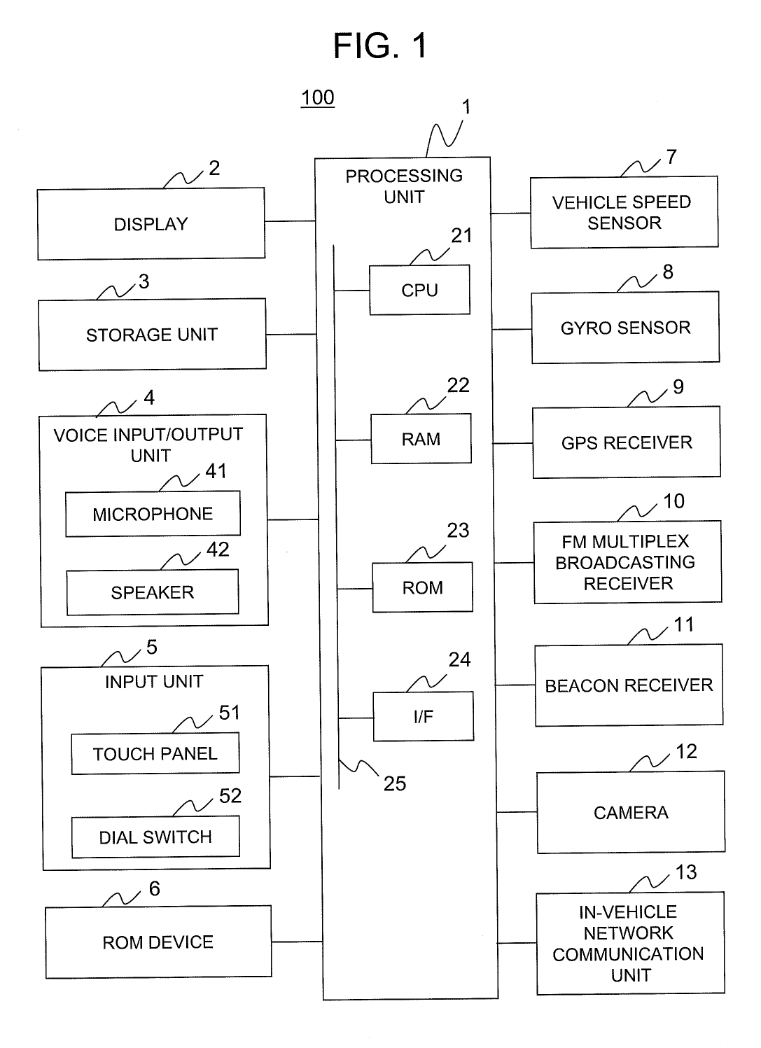

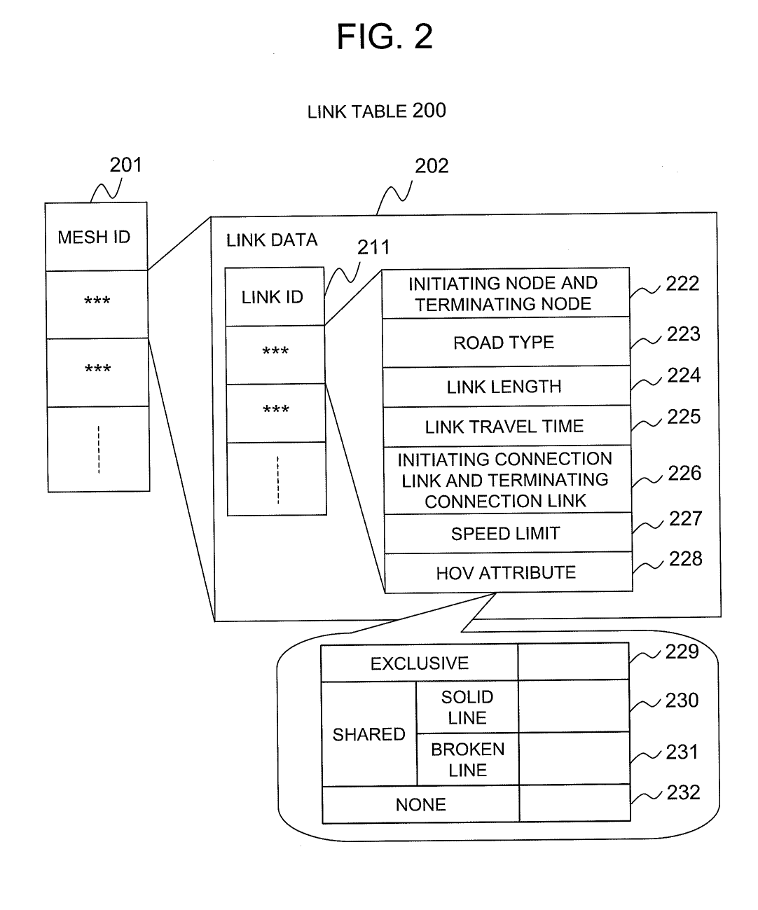

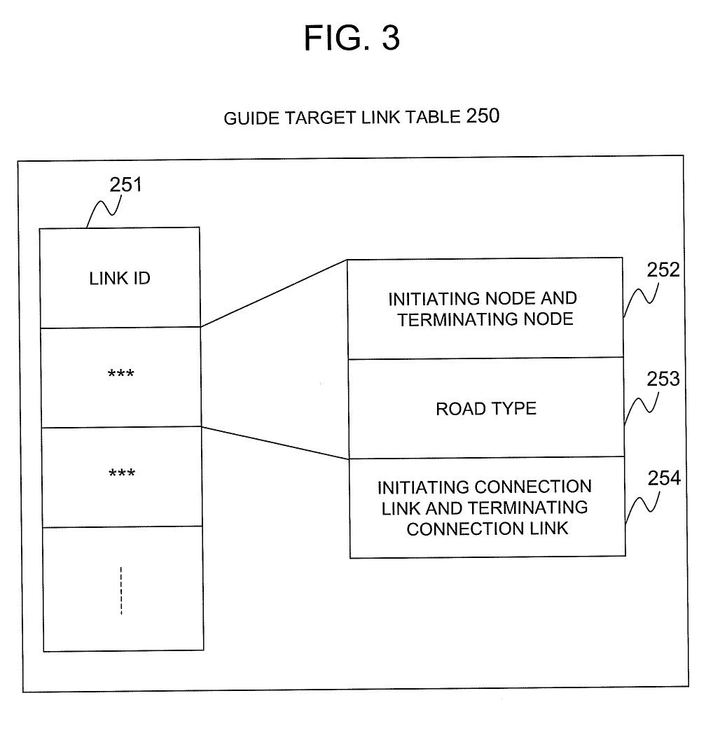

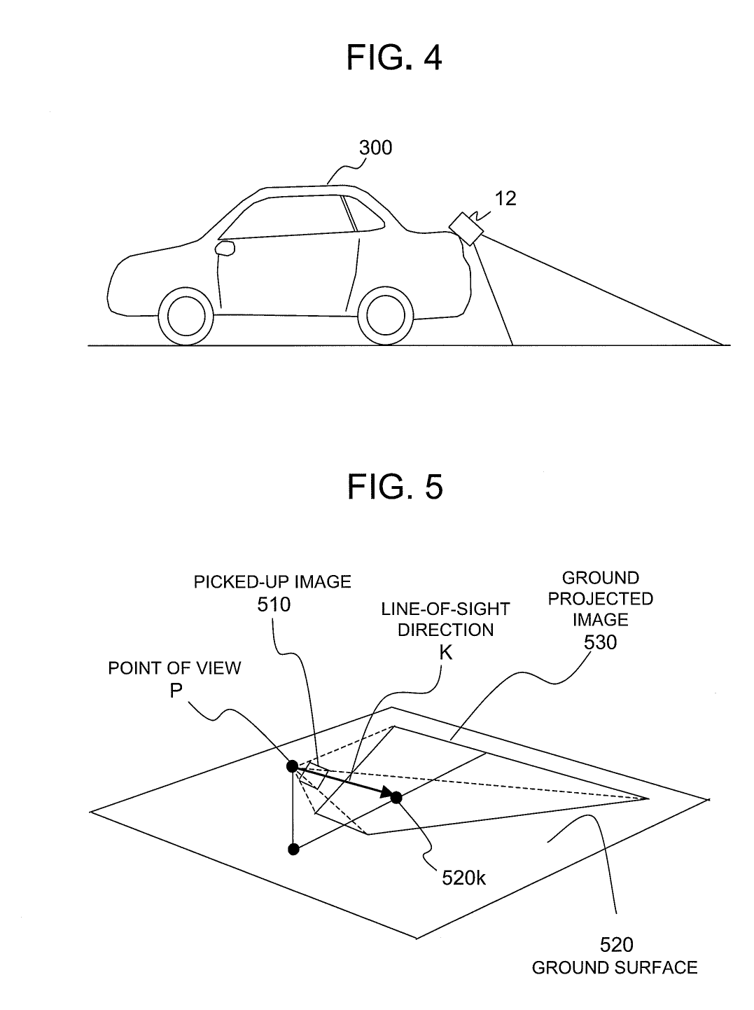

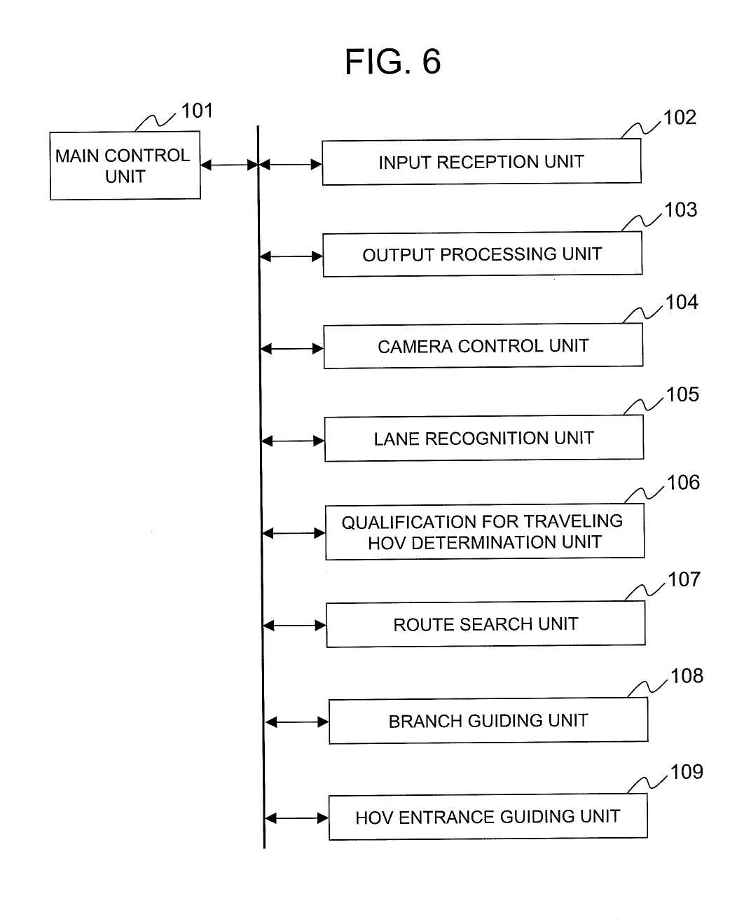

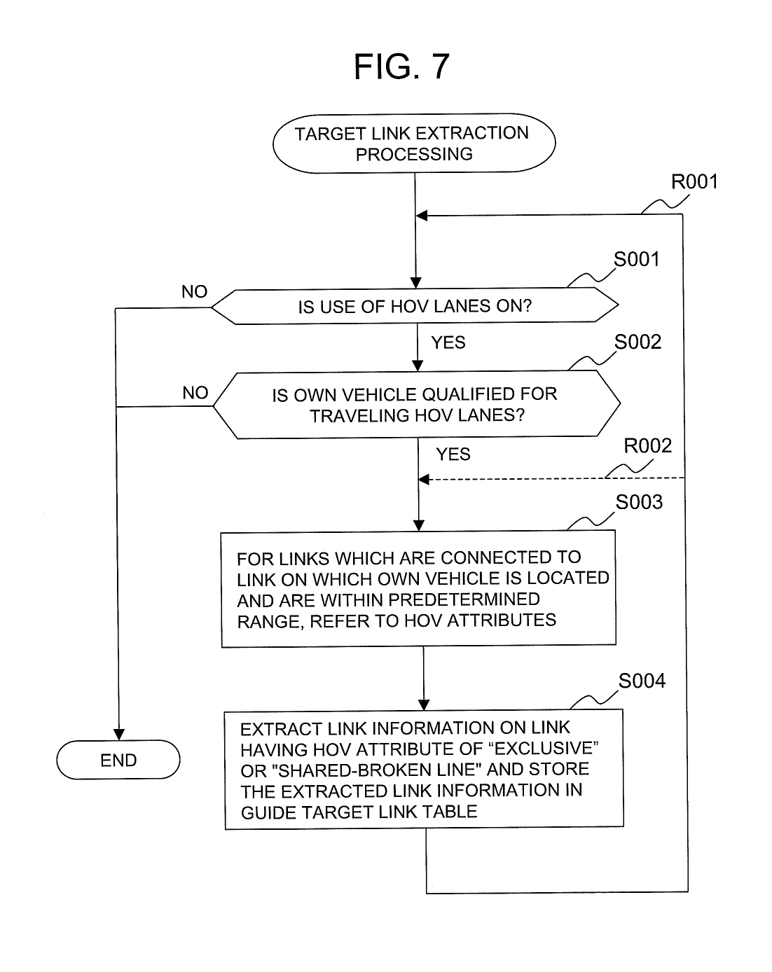

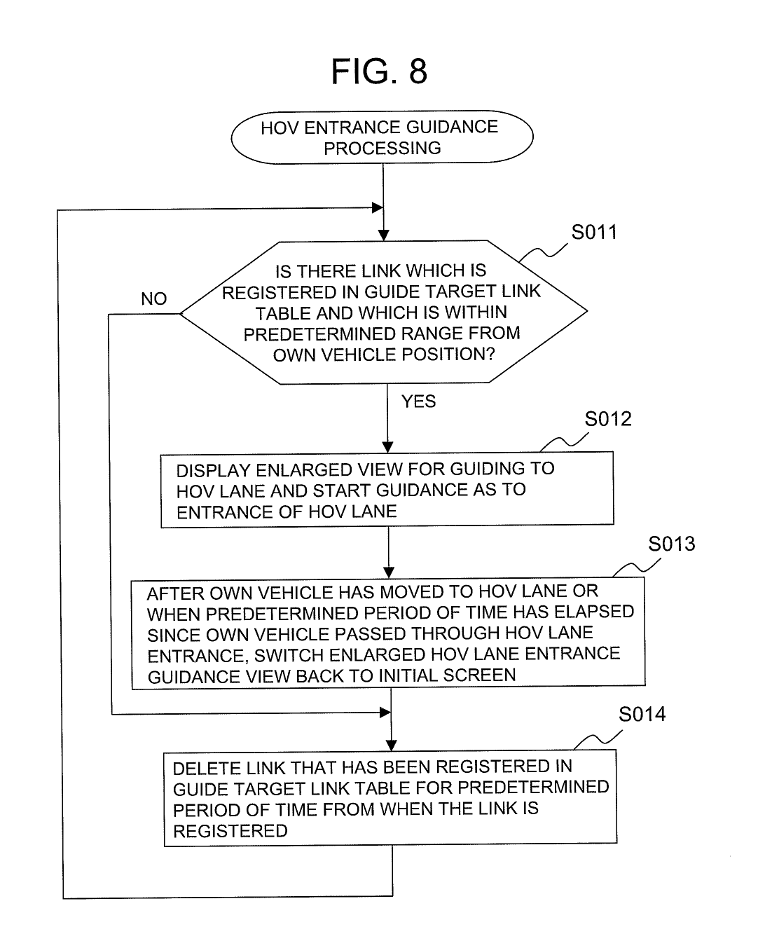

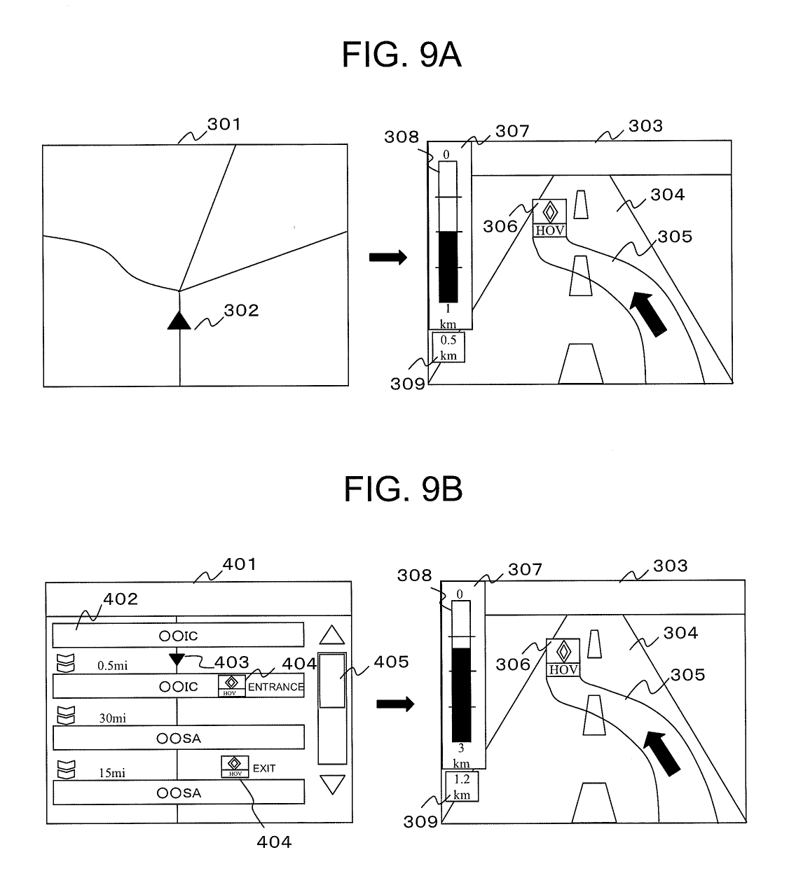

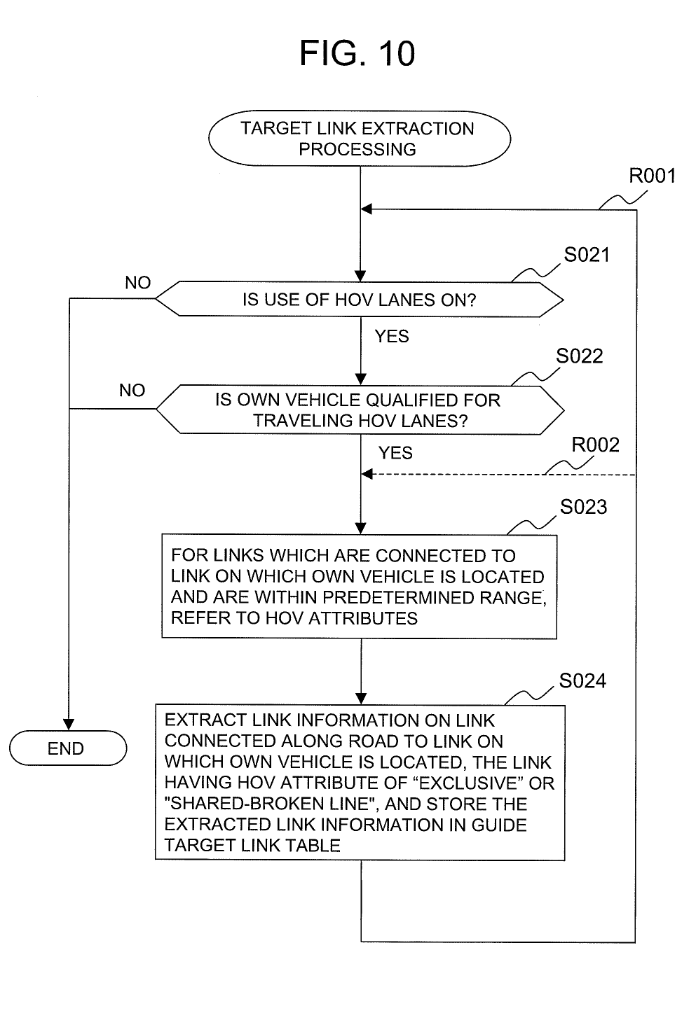

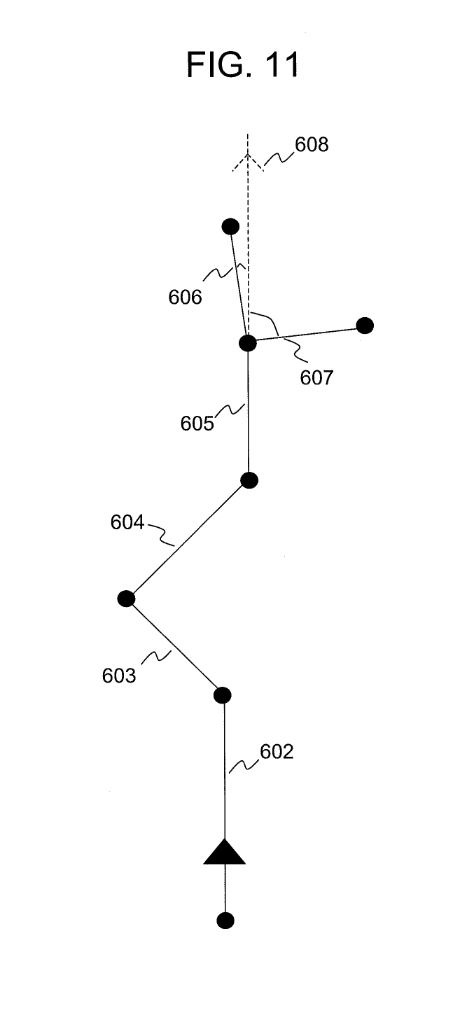

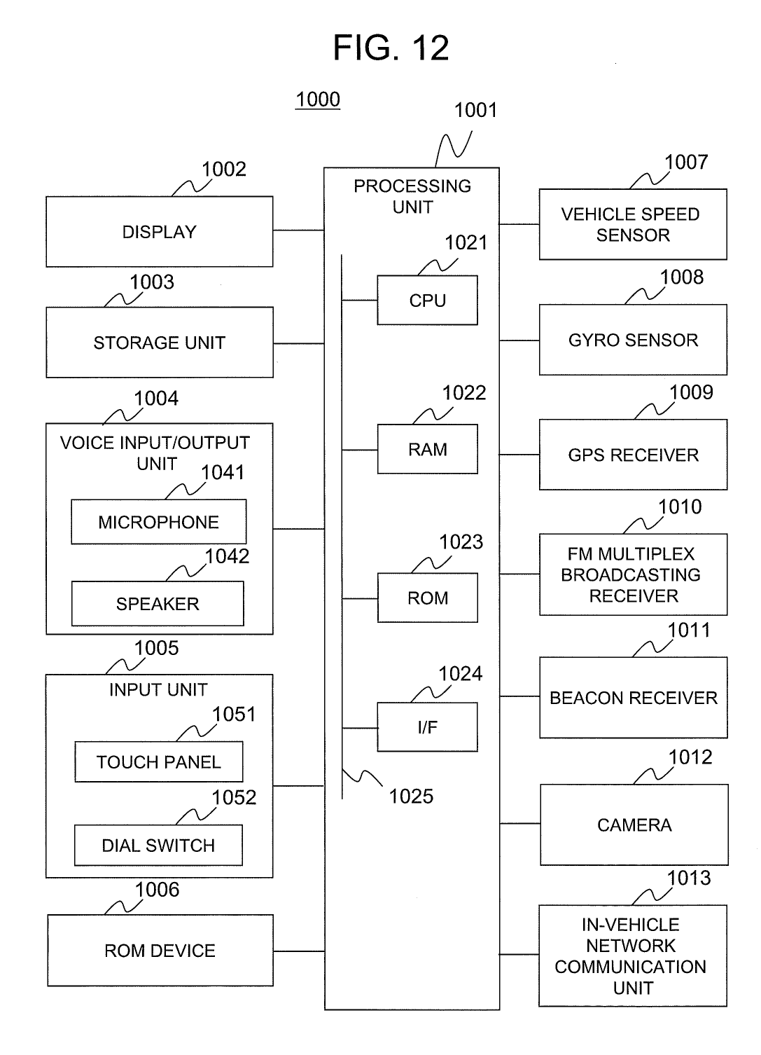

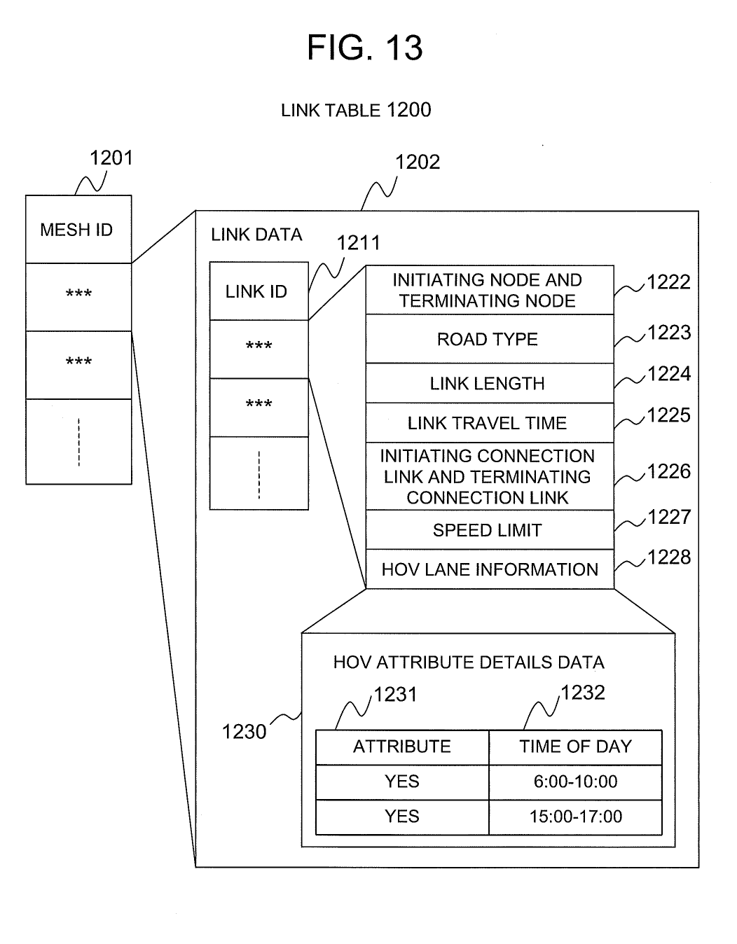

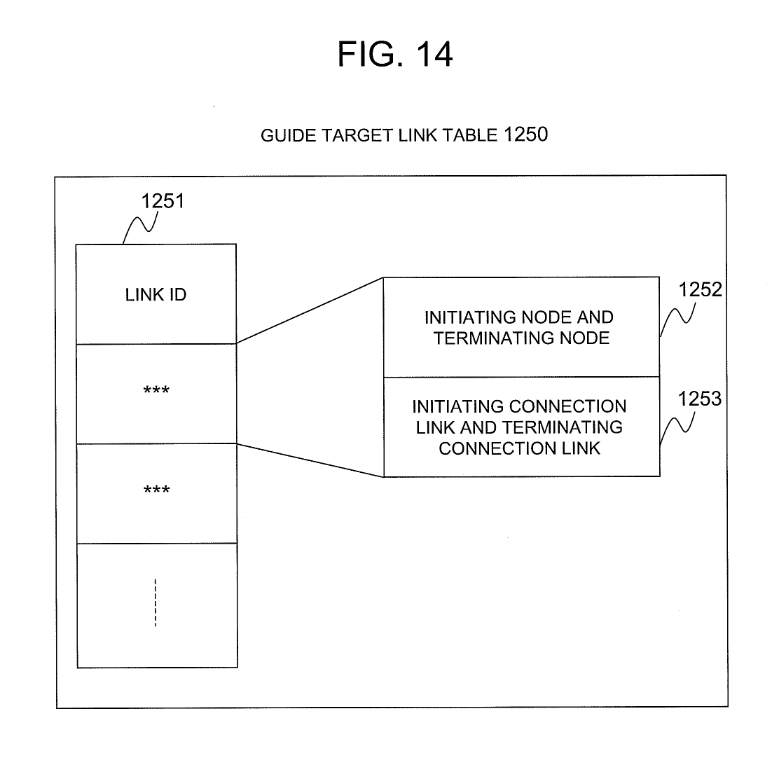

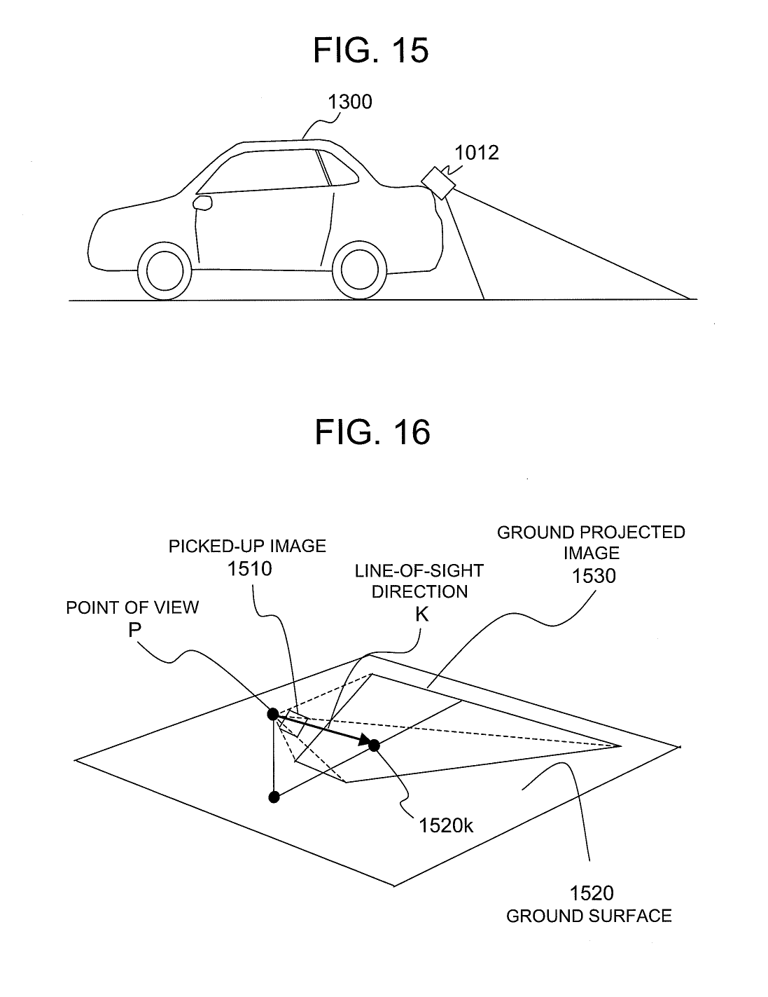

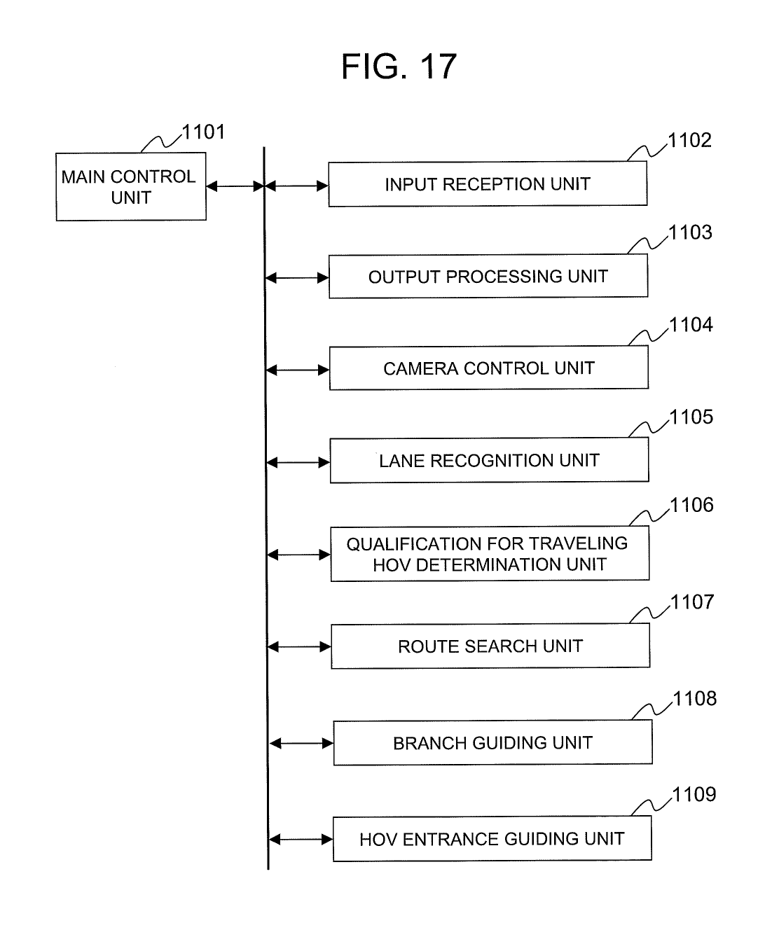

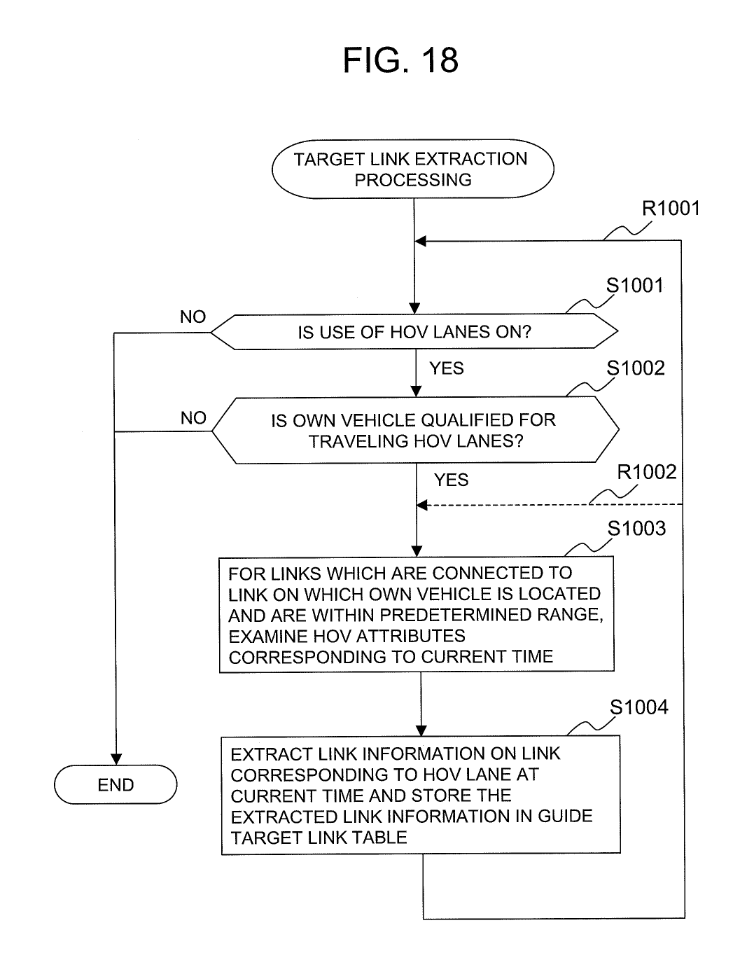

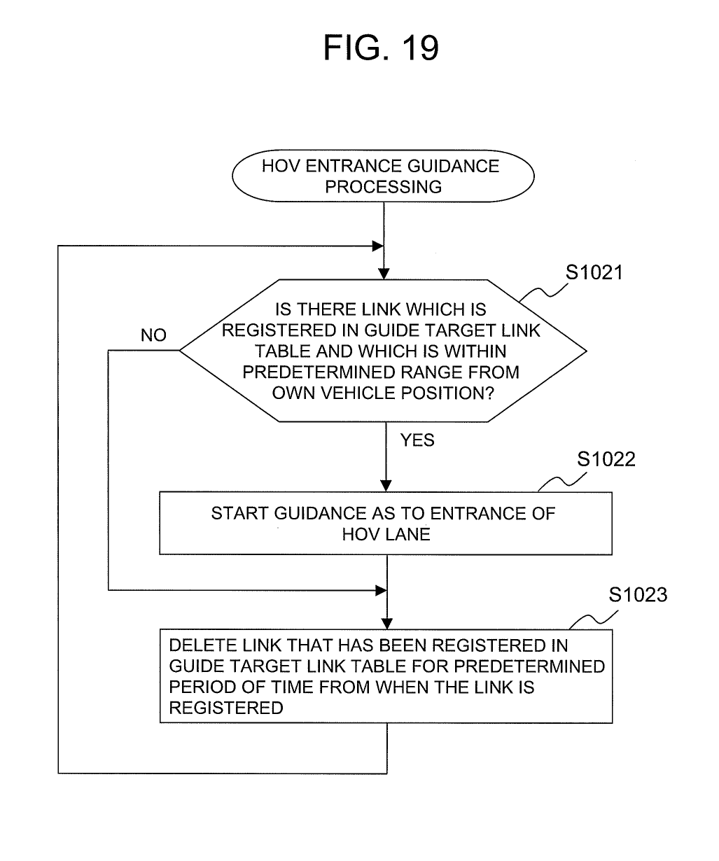

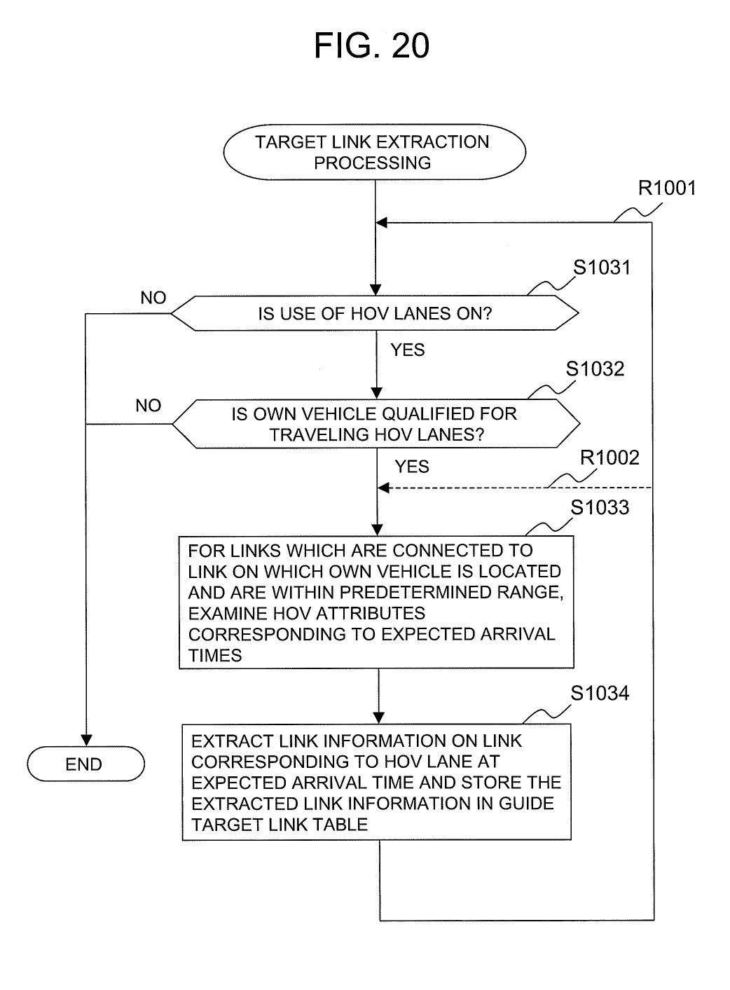

### BRIEF DESCRIPTION OF DRAWINGS

[FIG. 1] A schematic configuration diagram of a navigation device according to a first aspect of the present invention.

[FIG. 2] A diagram illustrating a configuration of a link table according to the first aspect of the present invention.

[FIG. 3] A diagram illustrating a configuration of a guide target link table according to the first aspect of the present invention.

[FIG. 4] A view illustrating a mounting position of a camera according to the first aspect of the present invention.

[FIG. 5] A diagram illustrating how a picked-up image is projected on a ground surface according to the first aspect of the present invention.

[FIG. 6] A functional block diagram of a processing unit according to a first embodiment of the first aspect of the present invention.

[FIG. 7] A flow chart of target link extraction processing according to the first aspect of the present invention.

[FIG. 8] A flow chart of HOV entrance guiding processing according to the first aspect of the present invention.

[FIG. 9] Example screens showing HOV lane entrance guidance views according to the first aspect of the present invention.

[FIG. 10] A flow chart of target link extraction processing according to a second embodiment of the first aspect of the present invention.

[FIG. 11] A diagram illustrating links connected along the road to a link on which an own vehicle is located according to the first aspect of the present invention.

[FIG. 12] A schematic configuration diagram of a navigation device according to a second aspect of the present invention.

[FIG. 13] A diagram illustrating a configuration of a link table according to the second aspect of the present invention.

[FIG. 14] A diagram illustrating a configuration of a guide target link table according to the second aspect of the present invention.

[FIG. 15] A view illustrating a mounting position of a camera according to the second aspect of the present invention.

[FIG. 16] A diagram illustrating how a picked-up image is projected on a ground surface according to the second aspect of the present invention.

[FIG. 17] A functional block diagram of a processing unit according to a first embodiment of the second aspect of the present invention.

[FIG. 18] A flow chart of target link extraction processing according to the second aspect of the present invention.

[FIG. 19] A flow chart of HOV entrance guiding processing according to the second aspect of the present invention.

[FIG. 20] A flow chart of target link extraction processing according to a second embodiment of the second aspect of the present invention.

### DESCRIPTION OF EMBODIMENTS

Hereinafter, embodiments of a first aspect and a second aspect of the present invention are described. Now, a navigation device to which a first embodiment of the first aspect of the present invention is applied is described with reference to the drawings.

FIG. 1 is an overall configuration diagram of a navigation device 100. The navigation device 100 is a so-called navigation device capable of displaying map information, and of showing a point indicating a present location of the navigation device 100 and information for guiding a route to a set destination.

The navigation device 100 includes a processing unit 1, a display 2, a storage unit 3, a voice input/output unit 4 (including a microphone 41 as a voice input unit and a speaker 42 as a voice output unit), an input unit 5, a ROM device 6, a vehicle speed sensor 7, a gyro sensor 8, a global positioning system (GPS) receiver 9, an FM multiplex broadcasting receiver 10, a beacon receiver 11, a camera 12, and an in-vehicle network communication unit 13.

The processing unit 1 is a central unit which performs various kinds of processing. For example, the processing unit 1 calculates the present location based on information output by, for example, the various sensors 7 and 8, the GPS receiver 9, the FM multiplex broadcasting receiver 10, and the like. Further, based on the obtained information on the present location, the processing unit 1 reads out map data necessary to be displayed, from the storage unit 3 or the ROM device 6.

Still further, the processing unit 1 graphically develops the map data thus read out, and displays the map data thus developed with a mark indicating the present location superimposed thereon, on the display 2. The processing unit 1 also makes a search for an optimal route (recommended route) which connects a departure place (present location) and a destination (or via point or stop-off point), which are designated by the user, by using the map data or the like stored in the storage unit 3 or the ROM device 6. In addition, the processing unit 1 provides the user with guidance by using the speaker 42 and the display 2.

Further, the processing unit 1 may give priority to a route for using HOV lanes in the route search as described below. Note that, an HOV lane is a traffic lane prescribed that only vehicles with a predetermined number of passengers (for example, two persons including the driver) or more, or vehicles satisfying predetermined criteria (low fuel consumption or low emission) are qualified for traveling.

The processing unit 1 of the navigation device 100 has a configuration in which devices are connected to one another by a bus 25. The processing unit 1 includes a central processing unit (CPU) 21 which executes various kinds of processing such as performing mathematical operations and control on each of the devices, a random access memory (RAM) 22 which stores the map data and operation data read out from the storage unit 3, a read only memory (ROM) 23 which stores programs and data, and an interface (I/F) 24 which connects various kinds of hardware to the processing unit 1.

The display 2 is a unit which displays graphic information created in the processing unit 1 or the like. The display 2 includes, for example, a liquid crystal display or an organic electroluminescence (EL) display.

The storage unit 3 includes a storage medium such as a hard disk drive (HDD) or a nonvolatile memory card, which is capable of at least reading and writing.

The storage medium stores a link table 200, which is the map data (including link data on links constituting roads on the map) necessary for a general route search device, and a guide target link table 250 in which links identified as HOV lanes are registered.

FIG. 2 is a diagram illustrating a configuration of the link table 200. The link table 200 contains, for each identification code (mesh ID) 201 for a mesh which is a partitioned area on the map, link data 202 on each of the links constituting roads included in the mesh area.

The link data 202 contains, for each link ID 211 which is an identifier of the link, coordinate information 222 on two nodes (initiating node and terminating node) which form the link, a road type 223 indicating a type of the road which includes the link (ordinary road, toll road, national highway, local street, or the like), a link length 224 indicating a length of the link, link travel time 225 which is stored in advance, an initiating connection link and terminating connection link 226 which identifies an initiating connection link, which is a link connected to the initiating node of the link, and a terminating connection link, which is a link connected to the terminating node of the link, a speed limit 227 indicating a speed limit of the road including the link, HOV lane information 228 for identifying an attribute regarding a status on whether or not an HOV lane is assigned for each link, and the like.

The HOV attribute 228 includes “exclusive”, “shared-solid line”, “shared-broken line”, and “none”. The HOV attribute 228 has a “exclusive” attribute 229 when the link is a road constituted only of HOV lanes, and a “none” attribute 232 when the link is a road that does not include an HOV lane. Alternatively, the HOV attribute 228 has a “shared-solid line” attribute 230 when the link is a road which includes both an HOV lane and a normal lane and in which a lane change between the HOV lane and the normal lane is not allowed, and a “shared-broken line” attribute 231 when the link is a road which includes both an HOV lane and a normal lane and in which a lane change between the HOV lane and the normal lane is allowed.

FIG. 3 is a diagram illustrating a configuration of the guide target link table 250. The guide target link table 250 is a table in which links extracted in HOV target link extraction processing, which is to be described later, are registered. Registered in the guide target link table 250 are a link ID 251 of the extracted link, an “initiating node and terminating node” 252 of the link, a road type 253, and an “initiating connection link and terminating connection link” 254. Note that, for the link ID 251, the “initiating node and terminating node” 252, the road type 253, and the “initiating connection link and terminating connection link” 254, the same ID number and coordinate information as those registered in the link table 200 are used.

Note that, in this example, the two nodes constituting the link are designated separately as the initiating node and the terminating node, and hence the upbound direction and the downbound direction of the same road are separately managed as different links.

Returning again to FIG. 1, further explanation is given. The voice input/output unit 4 includes the microphone 41 as a voice input unit and the speaker 42 as a voice output unit. The microphone 41 picks up a sound produced outside the navigation device 100, such as a voice uttered by the user or another passenger.

The speaker 42 outputs a message to the user, which is created in the processing unit 1, as a voice. The microphone 41 and the speaker 42 are separately disposed at predetermined positions in a vehicle, or may be integrally accommodated in a casing. The navigation device 100 may include a plurality of the microphones 41 and a plurality of the speakers 42.

The input unit 5 is a unit which receives an instruction from the user, through operations performed by the user. The input unit 5 includes a touch panel 51, a dial switch 52, and a scroll key, a zoom key, and the like as other hard switches (not shown). The input unit 5 also includes a remote controller capable of remotely issuing an operational instruction to the navigation device 100. The remote controller includes a dial switch, a scroll key, a zoom key, and the like. The remote controller delivers information obtained by operations of the keys and the switches to the navigation device 100.

The touch panel 51 is mounted on the display surface side of the display 2, allowing a display screen to be seen therethrough. The touch panel 51 identifies a touch position associated with the X and Y coordinates of an image displayed on the display 2, and outputs the touch position converted into a form of the coordinates. The touch panel 51 includes a pressure-sensitive or capacitive input detecting element or the like.

The dial switch 52 is configured to be rotatable in a clockwise direction or in a counter-clockwise direction, generates a pulse signal for each predetermined angle of rotation, and outputs the pulse signal to the processing unit 1. The processing unit 1 obtains the rotation angle based on the number of the pulse signals.

The ROM device 6 includes a storage medium such as a read only memory (ROM) including CD-ROM and DVD-ROM, or an integrated circuit (IC) card, which is at least readable. The storage medium stores, for example, moving image data and voice data.

The vehicle speed sensor 7, the gyro sensor 8, and the GPS receiver 9 are used for calculating a present location (own vehicle position) in the navigation device 100. The vehicle speed sensor 7 is a sensor which outputs a value to be used for calculating a vehicle speed. The gyro sensor 8 includes an optical-fiber gyroscope or a vibrating gyroscope, and detects an angular speed in accordance with the rotation of a moving object. The GPS receiver 9 receives a signal from a GPS satellite and measures, with respect to three or more satellites, a distance between a moving object and each of the GPS satellites and a rate of change in the distance, to thereby measure a present location, a traveling speed, and a traveling orientation of the moving object.

The FM multiplex broadcasting receiver 10 receives an FM multiplex broadcasting signal transmitted from an FM broadcasting station. The FM multiplex broadcasting includes general current traffic information, regulation information, service area/parking area (SA/PA) information, parking information, weather information, and the like, which are provided as Vehicle Information Communication System (VICS: registered trademark) information, and text information provided as FM multiplex general information by a radio station.

The beacon receiver 11 receives the general current traffic information, the regulation information, service area/parking area (SA/PA) information, the parking information, the weather information, which are provided as the VICS information, an emergency alert, and the like. The beacon receiver 11 is a receiver which receives, for example, an optical beacon communicated via light, a radio wave beacon communicated via radio waves, or the like.

FIG. 4 illustrates the camera 12 mounted on the back of a vehicle 300. The camera 12 faces slightly downward, and picks up an image of a ground surface at the rear of the vehicle by using an image pickup device such as a charge coupled device (CCD) or complementary metal oxide semiconductor (CMOS) image sensor. Note that, the position at which the camera 12 is mounted is not particularly limited, and for example, the camera 12 may be mounted at the front of the vehicle 300 and pick up an image of a ground surface in front of the vehicle.

FIG. 5 is a diagram illustrating a method of creating a ground projected image by using the image picked up by the camera 12 of FIG. 4. A camera control unit 104, which is to be described later, obtains a position of a point of view P of the camera 12 (coordinate position in a three-dimensional space with its origin at a predetermined position in the vehicle) and an image pickup direction (line-of-sight direction) K. Then, the camera control unit 104 projects a picked-up image 510 on a ground surface 520 from the position of the point of view P of the camera 12 toward the image pickup direction K, to thereby create a ground projected image 530. Note that, the image pickup direction K perpendicularly intersects the center of the picked-up image 510. Further, the distance from the point of view P of the camera 12 to the picked-up image 510 is determined in advance. The ground projected image 530 thus created is a bird' s eye view of the vehicle and its surroundings from above the vehicle.

The in-vehicle network communication unit 13 is a device which connects the navigation device 100 to a network (not shown) compliant to a control network specification of the vehicle, such as Controller Area Network (CAN), and performs communication by exchanging CAN messages to and from an electronic control unit (ECU), which is a control device of another vehicle connected to the network.

FIG. 6 is a functional block diagram of the processing unit 1. As illustrated in FIG. 6, the processing unit 1 includes a main control unit 101, an input reception unit 102, an output processing unit 103, the camera control unit 104, a lane recognition unit 105, a qualification for traveling HOV determination unit 106, a route search unit 107, a branch guiding unit 108, and an HOV entrance guiding unit 109.

The main control unit 101 is a central functional unit which performs various kinds of processing, and controls other processing units depending on the type of the processing. The main control unit 101 also acquires information on the various sensors, the GPS receiver 9, and the like, and performs map matching processing or the like to identify the present location. Further, the main control unit 101 outputs the current time in response to a request from the processing units. The main control unit 101 also manages various kinds of setting information contained in the navigation device 100. For example, the main control unit 101 receives the various kinds of setting information from the user through the functional units, and stores the various kinds of setting information in the storage unit 3. Note that, examples of the various kinds of setting information include information on the use of HOV lanes (for example, information on whether or not active use of HOV lanes is approved). When a request to acquire the various kinds of setting information is received from another functional unit, the main control unit 101 passes the information to the functional unit which has made the request.

The input reception unit 102 receives an instruction input by the user through the input unit 5 or the microphone 41, and controls each of the units of the processing unit 1 to execute processing corresponding to the request. For example, when the user makes a request to search a recommended route, the input reception unit 102 requests the output processing unit 103 to execute processing of displaying a map on the display 2 so that the destination may be set.

The output processing unit 103 receives, for example, screen information to display information, such as polygon information, converts the screen information to a signal to be rendered on the display 2, and instructs the display 2 to render the signal.

The camera control unit 104 controls operation of the camera 12. For example, the camera control unit 104 sets timings to start and end an image pick-up by the camera 12. The camera control unit 104 also controls transmission of the picked-up image to the lane recognition unit 105.

The lane recognition unit 105 acquires the image picked up by the camera 12 as image data. Then, the lane recognition unit 105 converts the acquired image to an image for display (ground projected image). The lane recognition unit 105 also recognizes signs and the like provided or colored on the surface of the road from the acquired image, and identifies a type of a traffic lane in which the own vehicle is traveling. For example, as described below, the lane recognition unit 105 recognizes the presence of a sign (painted rhomboid) or the like indicating an HOV lane, and when the sign is present around the horizontal center in the image, determines that the vehicle 300 is traveling an HOV lane. In a case where the sign is recognized not at around the horizontal center in the image, but at a position shifted to the left or the right from the around horizontal center, and is recognized on the side nearer the edge with respect to a sign of a traffic lane when viewed from around the horizontal center, the lane recognition unit 105 determines that the vehicle 300 is traveling a lane which is not an HOV lane and is adjacent to an HOV lane.

The qualification for traveling HOV determination unit 106 determines whether or not the own vehicle 300 is qualified for traveling HOV lanes. In determining the qualification, the qualification for traveling HOV determination unit 106 determines the type and the like of the own vehicle 300 based on the communication information flowing in an in-vehicle network of the own vehicle 300 through the in-vehicle network communication unit 13, and determines whether or not the own vehicle 300 is of a type qualified for traveling HOV lanes. It should be understood, however, that the processing of determining qualification for traveling HOV lanes is not limited thereto, and the qualification for traveling HOV determination unit 106 may determine the occupancy from load sensors (not shown) installed in seats of the vehicle or through seat belt buckle sensors, and determine whether or not the occupancy has reached an occupancy to qualify for traveling HOV lanes.

The route search unit 107 searches for an optimal route (recommended route) which connects the user specified departure place or the present location to the user specified destination. In the route search, the route search unit 107 searches for a route by using a route search logic such as the Dijkstra method, based on a link cost set in advance to a predetermined section (link) of the road. Note that, in the processing, the route search unit 107 requests the above-mentioned qualification for traveling HOV determination unit 106 to determine whether or not the own vehicle has a status to satisfy the qualification for traveling HOV lanes, and when a result of the determination is that the own vehicle has the status to satisfy the qualification for traveling, searches for a recommended route by giving priority to a route for using HOV lanes.

When the own vehicle does not have the status to satisfy the qualification for traveling, the route search unit 107 searches for a route having the minimum link cost without considering HOV lanes. Note that, in the processing, even in a case where it is determined that the own vehicle does not have the status satisfy the qualification for using HOV lanes, when the own vehicle is already traveling an HOV lane, the route search unit 107 searches for a recommended route by giving priority to a route for using HOV lanes. In determining whether or not the own vehicle is already traveling an HOV lane, the route search unit 107 refers to the HOV attribute 228 of the link to which the present location belongs, and determines that the own vehicle is traveling an HOV lane when the HOV attribute 228 is “exclusive” and that the own vehicle is not traveling an HOV lane when the HOV attribute 228 is “none”. Alternatively, when the HOV attribute 228 is “shared”, the route search unit 107 makes the determination by requesting the lane recognition unit 105 to determine whether or not the traffic lane being traveled by the own vehicle is an HOV lane.

The branch guiding unit 108 provides guidance to the driver as to the presence and position of a junction with another road, a branch to another road, and the like, by using a video or a voice. For example, the branch guiding unit 108 causes, through the output processing unit 103, the display 2 to output a display notifying of an approaching junction and an approximate distance to the junction, before a position where a feeder road and a main road of an expressway or the like meet. Alternatively, the branch guiding unit 108 notifies, at a point where a ramp road branches from a main road of an expressway, the driver of a correct traffic lane to take, with a voice through the speaker 42.

The HOV entrance guiding unit 109 is a functional unit which extracts link information on a link corresponding to an HOV lane and registers the link information in the guide target link table 250. Specifically, the HOV entrance guiding unit 109 refers to the HOV attributes 228 of links which are connected to the link on which the own vehicle is located and are within a predetermined range (for example, within 5 km), and identifies a link corresponding to an HOV lane. Then, the HOV entrance guiding unit 109 extracts information on the identified link and registers the extracted information in the guide target link table 250. The HOV entrance guiding unit 109 is also a functional unit which provides guidance as to an entrance of the HOV lane. Specifically, when the own vehicle approaches a link registered in the guide target link table 250 enough to be within a predetermined distance range (for example, 500 m to 600 m), the HOV entrance guiding unit 109 displays a guidance image for guiding the own vehicle to the HOV lane and starts guidance as to the entrance of the HOV lane.

The above-mentioned functional units of the processing unit 1 including the main control unit 101, the input reception unit 102, the output processing unit 103, the camera control unit 104, the lane recognition unit 105, the qualification for traveling HOV determination unit 106, the route search unit 107, the branch guiding unit 108, and the HOV entrance guiding unit 109 are implemented as the CPU 21 reads and executes predetermined programs. Therefore, the RAM 22 stores the programs for realizing the processing of the functional units.

Note that, the above-mentioned components represent the configuration of the navigation device 100 classified by the type of the processing mainly performed by the components for ease of understanding. Therefore, the invention of the subject application is not limited by how the components are classified or the names of the components. The configuration of the navigation device 100 may be classified into a larger number of components based on the type of processing performed by the components. Alternatively, the configuration may be classified so that one component executes a larger number of processing.

Alternatively, the functional units may be implemented by hardware (such as ASIC or GPU). Still alternatively, the processing of each of the functional units may be executed by one piece of hardware or a plurality of pieces of hardware.

Next, operation of the target link extraction processing performed by the navigation device 100 is described. FIG. 7 is a flow chart illustrating the target link extraction processing performed by the navigation device 100. This flow starts when the navigation device 100 is activated.

First, the HOV entrance guiding unit 109 determines whether or not HOV lanes can be used (Step S001). In other words, the HOV entrance guiding unit 109 determines whether or not the navigation device 100 is set to use HOV lanes (Step S001). Specifically, the HOV entrance guiding unit 109 acquires, from among the various kinds of setting information contained in the navigation device 100, information on the use of HOV lanes (for example, information on whether or not the use of HOV lanes is approved is set or not) from the main control unit 101. Then, the HOV entrance guiding unit 109 refers to the information to determine whether or not the setting is made to use HOV lanes.

When the setting is made to use HOV lanes (Yes in Step S001), the HOV entrance guiding unit 109 determines whether or not the own vehicle is qualified for traveling HOV lanes (Step S002). Specifically, the HOV entrance guiding unit 109 requests the qualification for traveling HOV determination unit 106 to determine whether or not the own vehicle is qualified for traveling HOV lanes. On the other hand, when the setting is not made to use HOV lanes (No in Step S001), the HOV entrance guiding unit 109 ends the target link extraction processing.

In Step S002, the qualification for traveling HOV determination unit 106 determines whether or not the own vehicle is qualified for traveling HOV lanes. Specifically, the qualification for traveling HOV determination unit 106 identifies the type or occupancy based on the type of the own vehicle or information obtained from the load sensors or the seat belt buckle sensors. Then, the qualification for traveling HOV determination unit 106 determines whether or not the identified type or occupancy satisfies predetermined conditions for using HOV lanes, and outputs a result of the determination to the HOV entrance guiding unit 109.

When the own vehicle is qualified for traveling HOV lanes (Yes in Step S002), the HOV entrance guiding unit 109 refers to the HOV attributes 228 of links which are connected to the link on which the own vehicle is located and are within the predetermined range (Step S003). Specifically, the HOV entrance guiding unit 109 identifies the link on which the own vehicle is located based on the information registered in the link table 200. Then, the HOV entrance guiding unit 109 refers to the HOV attributes 228 of links which are connected to the link on which the own vehicle is located and are within a range of 5 km or less from the own vehicle position, for example. On the other hand, when the own vehicle is not qualified for traveling HOV lanes (No in Step S002), the HOV entrance guiding unit 109 ends the target link extraction processing.

Note that, when the own vehicle is traveling a toll road, the HOV entrance guiding unit 109 refers to the HOV attributes 228 of links which are on the toll road and are within a predetermined range (for example, within 30 km) from the own vehicle position.

The HOV entrance guiding unit 109 refers to the attributes 228 of the links (Step S003), extracts a link for which “exclusive” or “shared-broken line” is registered in the HOV attribute 228, and stores the extracted link in the guide target link table 250 (Step S004).

After executing Step S004, the HOV entrance guiding unit 109 shifts the processing to Step S001 (R001). In this way, the HOV entrance guiding unit 109 repeatedly executes the processing of Steps S001 to S004.

Note that, after executing Step S004, the HOV entrance guiding unit 109 may shift the processing to Step S003 (R002). In this case, for example, after executing the processing of Steps S001 and S002, the HOV entrance guiding unit 109 may repeatedly execute the processing of Steps S003 and S004 (R002) and shift the processing to Step S001 at a predetermined timing (R001). Specifically, the HOV entrance guiding unit 109 may repeatedly execute the processing of Steps S003 and S004 and shift the processing to Step S001 at timings of every 10 minutes, for example (R001).

Next, referring to FIG. 8, HOV entrance guiding processing is described. FIG. 8 is a flow chart illustrating the HOV entrance guiding processing.

The HOV entrance guiding unit 109 determines whether or not there is a link which is stored in the guide target link table 250 by the target link extraction processing and which is within the predetermined range from the own vehicle position (Step S011). Specifically, the HOV entrance guiding unit 109 examines presence or absence of a link which is stored in the guide target link table 250 and which is at a distance within a range of 500 m to 600 m from the own vehicle position, for example. When there is such link (Yes in Step S011), the HOV entrance guiding unit 109 shifts the processing to Step S012. On the other hand, when there is no link within the predetermined range from the own vehicle position (No in Step S011), the HOV entrance guiding unit 109 shifts the processing to Step S013.

In Step S011, when there is a link within the predetermined range from the own vehicle position (Yes in Step S011), the HOV entrance guiding unit 109 starts guidance as to the entrance of the HOV lane (Step S012), and shifts the processing to Step S023. Specifically, the HOV entrance guiding unit 109 displays an image for guiding the own vehicle to the HOV lane on the display 2.

Note that, as the entrance guidance image for guiding the own vehicle to the HOV lane, an image that is enlarged compared to a normal guidance image of a branch (right turn or left turn) is displayed. Specifically, compared to the normal branch guidance, the road is displayed in a manner that the width thereof is appeared wider, and an arrow for encouraging a lane change is displayed in a manner that the size thereof is appeared larger. Displaying such enlarged image provides an advantage that the guidance as to the entrance of the HOV lane is more easily seen by a fellow passenger even with a small display 2. The conditions required for traveling HOV lanes include, for example, that two or more passengers must be in the vehicle. Therefore, it is assumed that the vehicle using HOV lanes often carries a fellow passenger other than a driver. Therefore, when the guidance as to the entrance of the HOV lane is displayed as an enlarged view that is more easily seen by the fellow passenger, the fellow passenger may provide the guidance as to the entrance of the HOV lane more easily. On the other hand, when too large a guidance image is displayed in the normal branch guidance, the guidance image becomes rather difficult to see. Therefore, such display of the enlarged guidance image of the HOV lane provides an advantage specific to the guidance as to the entrance of the HOV lane.

Note that, configuration of such HOV entrance guidance image is described later. Further, the HOV entrance guiding unit 109 executes voice guidance through the speaker 42 along with the display of the entrance guidance image.

In Step S013, after the own vehicle has moved to the HOV lane, or after a predetermined period of time has elapsed since the own vehicle passed through the HOV lane entrance, the HOV entrance guiding unit 109 switches the entrance guidance image that is being displayed back to the map image or the like that was displayed before the entrance guidance image. Specifically, the HOV entrance guiding unit 109 requests the lane recognition unit 105 to determine whether or not the own vehicle is traveling an HOV lane. When the own vehicle is traveling an HOV lane, or when the predetermined period of time has elapsed since the own vehicle passed through the HOV lane entrance, the HOV entrance guiding unit 109 displays again the map image or the like that was displayed before the entrance guidance image of the HOV lane that is being displayed on the display 2. Then, the HOV entrance guiding unit 109 shifts the processing to Step S104.

In Step S014, the HOV entrance guiding unit 109 deletes a link that has been stored in the guide target link table 250 for a predetermined period of time from when the link is stored. Specifically, the HOV entrance guiding unit 109 deletes, of the links stored in the guide target link table 250, information on a link that has been stored for one hour or more from when the link is stored. Note that, such period of time for which a link is stored may be set as appropriate. Alternatively, instead of setting the predetermined period of time for which a link is stored as a requirement for deleting the link, the HOV entrance guiding unit 109 may delete a registered link when the own vehicle position moves away from the registered link by a predetermined distance or more, for example. The predetermined distance may also be set as appropriate. Note that, in the HOV entrance guiding processing illustrated in FIG. 8, the processing of Steps S011 to S014 is repeatedly executed while the target link extraction processing is executed.

Hereinabove, the flows of the target link extraction processing and the HOV entrance guiding processing have been described.

Next, an example screen of the navigation device 100 after execution of the target link extraction processing and the HOV entrance guiding processing is described. FIG. 9A is an example screen in which the guidance as to the entrance of the HOV lane is displayed while the vehicle is traveling an ordinary road. FIG. 9B is an example screen in which the guidance as to the entrance of the HOV lane is displayed while the vehicle is traveling a toll road. Note that, the same reference symbols are used for the same parts, and description thereof is omitted.

An example screen 301 of FIG. 9A is a map image indicating a position 302 of the own vehicle that is traveling an ordinary road. When a link stored in the guide target link table 250 is located within a range of 500 m to 600 m from the own vehicle position, the HOV entrance guiding unit 109 displays an entrance guidance view 303 of an HOV lane on the display 2 (Steps S011 to S014). As illustrated in FIG. 9A, the entrance guidance view 303 is displayed as an image obtained by enlarging a portion from the own vehicle position to the entrance of the HOV lane.

Shown in the entrance guidance view 303 are a front road graphic 304 showing a front road, a travel lane indication graphic 305 indicating a travel lane, an HOV lane graphic 306 indicating that there is an HOV lane ahead, a distance indication graphic 307 for graphically indicating a distance to a point of entry to the HOV lane, a distance meter 308 displayed to be superimposed on the distance indication graphic, and a distance indication 309 for numerically indicating the distance to the point of entry to the HOV lane.

As shown in the example screen 303, the distance meter 308 and the distance indication 309 indicate the distance to the point of entry to the HOV lane so that the driver can easily understand the timing to steer a vehicle into a direction of the HOV lane entrance. Further, at a position ahead of the travel lane indication graphic 305, the HOV lane graphic 306 is displayed so that the driver can easily be aware that the vehicle is about to be entered the HOV lane and the correct travel lane leads to the HOV lane. Further, the entrance guidance image of the HOV lane is displayed as an image that is enlarged compared to the normal branch guidance. As a result, the entrance guidance image is displayed in a manner that is easy to see not only for the driver but also for a fellow passenger.

An example screen 401 of FIG. 9B displays an image showing the own vehicle position on a toll road. Note that, when the own vehicle is traveling a toll road, the HOV entrance guiding unit 109 extracts a target link as to which the entrance guidance is to be provided, from links on the toll road on which the own vehicle is located, and stores the target link in the guide target link table 250 (Steps S001 to S004).

Displayed on the example screen 401 are check point graphics 402 indicating check points such as an interchange or a service area, an own vehicle position graphic 403, graphics 404 indicating entrance/exit information on an HOV lane, and a scroll operation graphic 405 for receiving an instruction to scroll the screen.

The HOV entrance guiding unit 109 repeatedly executes the processing of Steps S001 to S004 to store links which are on the toll road and which have the HOV attributes 228 of “shared-broken line” in the guide target link table 250.

Further, based on position information on the link stored in the guide target link table 250, the HOV entrance guiding unit 109 identifies a link that is closest to the own vehicle position. Then, the HOV entrance guiding unit 109 regards such link as an entrance to an HOV lane, and displays the graphic 404 indicating the entrance/exit information on the HOV lane to be superimposed on the check point graphic 402 or between check points.

Further, based on the position information on the link stored in the guide target link table 250, the HOV entrance guiding unit 109 identifies a link which is the closest to the own vehicle position, other than the link that is regarded as the entrance to the HOV lane, and which has the HOV attribute 228 of “shared-broken line”. Then, the HOV entrance guiding unit 109 regards such link as an exit of the HOV lane, and displays the graphic 404 indicating the entrance/exit information on the HOV lane to be superimposed on the check point graphic 402 or between check points.

Next, when there is a link, among the links registered in the guide target link table 250, that is within a predetermined range from the own vehicle position, the HOV entrance guiding unit 109 displays the entrance guidance view 303 of the HOV lane on the display 2. Specifically, when there is a link that is an entrance to an HOV lane within a range of, for example, 1 km to 1.2 km from the own vehicle position, the HOV entrance guiding unit 109 displays the entrance guidance view 303 of the HOV lane on the display 2 (Steps S011 to S014). At this time, the entrance guidance image of the HOV lane is displayed as an enlarged image compared to the normal branch guidance. As a result, the entrance guidance image is displayed in a manner that is easy to see not only for the driver but also for a fellow passenger.

As described above, the navigation device according to the first embodiment of the first aspect of the present invention executes guidance as to the entrance of the HOV lane that is within the predetermined range from the own vehicle with the enlarged view. Therefore, according to the present invention, the guidance can be provided by visually displaying the HOV lane in a manner that is easier to see.

Note that, the navigation device 100 according to the first embodiment described above extracts link information on the link having the HOV attribute 228 of “exclusive” or “shared-broken line”, but the present invention is not limited thereto. According to the navigation device 100 of a second embodiment of the first aspect of the present invention, link information on a link connected along the road to the link on which the own vehicle is located is further displayed. Referring to FIG. 10, operation of the navigation device 100 according to the second embodiment of the first aspect of the present invention is described.

FIG. 10 is a flow chart illustrating target link extraction processing performed by the navigation device 100 according to the second embodiment. In the second embodiment, all the processing other than Step s024 show the same processing executed in the first embodiment. Therefore, the description of the types of processing similar to those of the first embodiment is omitted. Further, the flow illustrated in FIG. 10 starts when the navigation device 100 is activated.

In Step S024 of FIG. 10, the HOV entrance guiding unit 109 extracts link information on a link connected along the road to the link on which the own vehicle is located, the link having the HOV attribute 228 of “exclusive” or “shared-broken line”. Specifically, when a plurality of links are not connected to the terminating node of the link on which the own vehicle is located, the HOV entrance guiding unit 109 identifies a link connected to the link on which the own vehicle is located as a link along the road.

On the other hand, when a plurality of links are connected to the terminating node of the link on which the own vehicle is located, the HOV entrance guiding unit 109 identifies, of the plurality of links, a link having the smallest difference from a link orientation of the link on which the own vehicle is located as the link along the road. For example, as illustrated in FIG. 11, only one link is connected to a terminating node of a link 602 on which an own vehicle position 601 is located. In this case, the HOV entrance guiding unit 109 identifies a link 603 connected to the terminating node of the link 602 as the link along the road.

Further, only one link 604 is connected to a terminating node of the link 603, and hence the HOV entrance guiding unit 109 identifies the link 604 as the link connected along the road to the link 603.

In this example, two links, that is, a link 606 and a link 607 are connected to a terminating node of a link 605. In this case, the HOV entrance guiding unit 109 identifies the link 606, which is a link having the smallest difference from a link orientation 608 of the link 605 as the link along the road.

Further, the HOV entrance guiding unit 109 tracks links which are connected to the link on which the own vehicle is located and are within a predetermined range (for example, within 5 km), to identify the links along the road.

Then, the HOV entrance guiding unit 109 extracts a link which is identified as the link along the road and has the HOV attribute 228 of “exclusive” or “shared-broken line”, and stores the extracted link in the guide target link table 250.

Note that, in identifying the link along the road, the road type of the link table may be referred to, for example. That is, when a plurality of links are connected to a terminating node of a certain link, a link having the same road type as the road type (for example, national highway) of the certain link may be identified as a link connected along the road to the link.

Note that, also in the second embodiment of the first aspect of the present invention as described above, the HOV entrance guiding processing is executed as in the first embodiment.

As described above, according to the second embodiment of the first aspect of the present invention, entrance guidance can be provided only for the HOV lane on the link along the road. In other words, guidance as to an HOV lane that appears after turning right or left from the link on which the own vehicle is located can be restricted. As a result, the number of times of entrance guidance as to the HOV lane can be suppressed, and the guidance as to the HOV lane can be provided by visually displaying the HOV lane in a manner that is easier to see.

Next, a navigation device to which a first embodiment of the second aspect of the present invention is applied is described with reference to the drawings.

FIG. 12 is an overall configuration diagram of a navigation device 1000. The navigation device 1000 is a so-called navigation device capable of displaying map information, and of showing a point indicating a present location of the navigation device 1000 and information for guiding a route to a set destination.

The navigation device 1000 includes a processing unit 1001, a display 1002, a storage unit 1003, a voice input/output unit 1004 (including a microphone 1041 as a voice input unit and a speaker 1042 as a voice output unit), an input unit 1005, a ROM device 1006, a vehicle speed sensor 1007, a gyro sensor 1008, a global positioning system (GPS) receiver 1009, an FM multiplex broadcasting receiver 1010, a beacon receiver 1011, a camera 1012, and an in-vehicle network communication unit 1013.

The processing unit 1001 is a central unit which performs various kinds of processing. For example, the processing unit 1001 calculates the present location based on information output by, for example, the various sensors 1007 and 1008, the GPS receiver 1009, the FM multiplex broadcasting receiver 1010, and the like. Further, based on the obtained information on the present location, the processing unit 1001 reads out map data necessary for display, from the storage unit 1003 or the ROM device 1006.

Still further, the processing unit 1001 graphically develops the map data thus read out, and displays the map data thus developed with a mark indicating the present location superimposed thereon, on the display 1002. The processing unit 1001 also makes a search for an optimal route (recommended route) which connects a departure place (present location) and a destination (or via point or stop-off point), which are designated by the user, by using the map data or the like stored in the storage unit 1003 or the ROM device 1006. In addition, the processing unit 1001 provides the user with guidance by using the speaker 1042 and the display 1002.

Further, the processing unit 1001 may give priority to a route for traveling HOV lanes in the route search as described below. Note that, an HOV lane is a traffic lane prescribed that only vehicles with a predetermined number of passengers (for example, two persons including the driver) or more, or vehicles satisfying predetermined criteria (low fuel consumption or low emission) are qualified for traveling.

The processing unit 1001 of the navigation device 1000 has a configuration in which devices are connected to one another by a bus 1025. The processing unit 1001 includes a central processing unit (CPU) 1021 which executes various kinds of processing such as performing mathematical operations and control on each of the devices, a random access memory (RAM) 1022 which stores the map data and operation data read out from the storage unit 1003, a read only memory (ROM) 1023 which stores programs and data, and an interface (I/F) 1024 which connects various kinds of hardware to the processing unit 1001.

The display 1002 is a unit which displays graphic information created in the processing unit 1001 or the like. The display 1002 includes, for example, a liquid crystal display or an organic electroluminescence (EL) display.

The storage unit 1003 includes a storage medium such as a hard disk drive (HDD) or a nonvolatile memory card, which is capable of at least reading and writing.

The storage medium stores a link table 1200, which is the map data (including link data on links constituting roads on the map) necessary for a general route search device, and a guide target link table 1250 in which links identified as HOV lanes are registered.

FIG. 13 is a diagram illustrating a configuration of the link table 1200. The link table 1200 contains, for each identification code (mesh ID) 1201 for a mesh which is a partitioned area on the map, link data 1202 on each of the links constituting roads included in the mesh area.

The link data 1202 contains, for each link ID 1211 which is an identifier of the link, coordinate information 1222 on two nodes (initiating node and terminating node) which form the link, a road type 1223 indicating a type of the road which includes the link, a link length 1224 indicating a length of the link, link travel time 1225 which is stored in advance, an initiating connection link and terminating connection link 1226 which identifies an initiating connection link, which is a link connected to the initiating node of the link, and a terminating connection link, which is a link connected to the terminating node of the link, a speed limit 1227 indicating a speed limit of the road including the link, HOV lane information 1228 for identifying an attribute regarding a status on whether or not an HOV lane is provided for each link, and the like.

The HOV lane information 1228 contains HOV attribute details data 1230 indicating whether or not the link can be an HOV lane. In the HOV attribute details data 1230, an attribute 1231 indicating whether or not an HOV lane is provided to the link, and when an HOV lane is provided, a time of day 1232 when the HOV lane is provided are registered in association with each other. Specifically, when an HOV lane is provided to the link, “YES” is registered in the attribute 1231. Also, times of day (for example, 6:00 to 10:00, 15:00 to 17:00, and the like) when the link is an HOV lane are registered in association with the attributes 1231 indicating “YES”.

FIG. 14 is a diagram illustrating a configuration of the guide target link table 1250. The guide target link table 1250 is a table in which links extracted in HOV target link extraction processing, which is to be described later, are registered. Registered in the guide target link table 1250 are a link ID 1251 of the extracted link, an “initiating node and terminating node” 252 of the link, and an “initiating connection link and terminating connection link” 1253. Note that, for the link ID 1251, the “initiating node and terminating node” 1252, and the “initiating connection link and terminating connection link” 1253, the same ID number and coordinate information as those registered in the link table 1200 are used.

Note that, in this example, the two nodes constituting the link are differentiated from each other as the initiating node and the terminating node, and hence the upbound direction and the downbound direction of the same road are separately managed as different links.

Returning again to FIG. 12, further description is given. The voice input/output unit 4 includes the microphone 1041 as a voice input unit and the speaker 1042 as a voice output unit. The microphone 1041 picks up a sound produced outside the navigation device 1000, such as a voice uttered by the user or another passenger.

The speaker 1042 outputs a message to the user, which is created in the processing unit 1000, as a voice. The microphone 1041 and the speaker 1042 are separately disposed at predetermined positions in a vehicle, or may be integrally accommodated in a casing. The navigation device 1000 may include a plurality of the microphones 1041 and a plurality of the speakers 1042.

The input unit 1005 is a unit which receives an instruction from the user, through operations performed by the user. The input unit 1005 includes a touch panel 1051, a dial switch 1052, and a scroll key, a zoom key, and the like as other hard switches (not shown). The input unit 1005 also includes a remote controller capable of remotely issuing an operational instruction to the navigation device 1000. The remote controller includes a dial switch, a scroll key, a zoom key, and the like. The remote controller delivers information corresponding to operations on the keys and the switches to the navigation device 1000.

The touch panel 1051 is mounted on the display surface side of the display 1002, allowing a display screen to be seen therethrough. The touch panel 1051 identifies a touch position which is associated with the X and Y coordinates of an image displayed on the display 1002, and outputs the touch position converted into a form of the coordinates. The touch panel 1051 includes a pressure-sensitive or capacitive input detecting element or the like.

The dial switch 1052 is configured to be rotatable in a clockwise direction or in a counter-clockwise direction, generates a pulse signal for each predetermined angle of rotation, and outputs the pulse signal to the processing unit 1001. The processing unit 1001 obtains the rotation angle based on the number of the pulse signals.

The ROM device 1006 includes a storage medium such as a read only memory (ROM) including CD-ROM and DVD-ROM, or an integrated circuit (IC) card, which is at least readable. The storage medium stores, for example, moving image data and voice data.

The vehicle speed sensor 1007, the gyro sensor 1008, and the GPS receiver 1009 are used for calculating a present location (own vehicle position) in the navigation device 1000. The vehicle speed sensor 1007 is a sensor which outputs a value to be used for calculating a vehicle speed. The gyro sensor 1008 includes an optical-fiber gyroscope or a vibrating gyroscope, and detects an angular speed in accordance with the rotation of a moving object. The GPS receiver 1009 receives a signal from a GPS satellite and measures, with respect to three or more satellites, a distance between a moving object and each of the GPS satellites and a rate of change in the distance, to thereby measure a present location, a traveling speed, and a traveling orientation of the moving object.

The FM multiplex broadcasting receiver 1010 receives an FM multiplex broadcasting signal transmitted from an FM broadcasting station. The FM multiplex broadcasting includes general current traffic information, regulation information, service area/parking area (SA/PA) information, parking information, weather information, and the like, which are provided as Vehicle Information Communication System (VICS: registered trademark) information, and text information provided as FM multiplex general information by a radio station.

The beacon receiver 1011 receives the general current traffic information, the regulation information, service area/parking area (SA/PA) information, the parking information, the weather information, which are provided as the VICS information, an emergency alert, and the like. The beacon receiver 1011 is a receiver which receives, for example, an optical beacon communicated via light, a radio wave beacon communicated via radio waves, or the like.

FIG. 15 illustrates the camera 1012 mounted on the back of a vehicle 1300. The camera 1012 faces slightly downward, and picks up an image of a ground surface at the rear of the vehicle by using an image pickup device such as a charge coupled device (CCD) or complementary metal oxide semiconductor (CMOS) image sensor. Note that, the position at which the camera 1012 is mounted is not particularly limited, and for example, the camera 1012 may be mounted at the front of the vehicle 1300 and pick up an image of a ground surface in front of the vehicle.

FIG. 16 is a diagram illustrating a method of creating a ground projected image by using the image picked up by the camera 1012 of FIG. 15. A camera control unit 1104, which is to be described later, obtains a position of a point of view P of the camera 1012 (coordinate position in a three-dimensional space with its origin at a predetermined position in the vehicle) and an image pickup direction (line-of-sight direction) K. Then, the camera control unit 1104 projects a picked-up image 1510 on a ground surface 1520 from the position of the point of view P of the camera 1012 toward the image pickup direction K, to thereby create a ground projected image 1530. Note that, the image pickup direction K perpendicularly intersects the center of the picked-up image 1510. Further, the distance from the point of view P of the camera 1012 to the picked-up image 1510 is determined in advance. The ground projected image 1530 thus created is a bird' s eye view of the vehicle and its surroundings from above the vehicle.

The in-vehicle network communication unit 1013 is a device which connects the navigation device 1000 to a network (not shown) compliant to a control network specification of the vehicle, such as Controller Area Network (CAN), and performs communication by exchanging CAN messages to and from an electronic control unit (ECU), which is another vehicle control device connected to the network.

FIG. 17 is a functional block diagram of the processing unit 1001. As illustrated in FIG. 17, the processing unit 1001 includes a main control unit 1101, an input reception unit 1102, an output processing unit 1103, the camera control unit 1104, a lane recognition unit 1105, a qualification for traveling HOV determination unit 1106, a route search unit 1107, a branch guiding unit 1108, and an HOV entrance guiding unit 1109.

The main control unit 1101 is a central functional unit which performs various kinds of processing, and controls other processing units depending on the type of the processing. The main control unit 1101 also acquires information on the various sensors, the GPS receiver 1009, and the like, and performs map matching processing or the like to identify the present location. Further, the main control unit 1101 outputs the current time in response to a request from the processing units. The main control unit 1101 also manages various kinds of setting information contained in the navigation device 1000. For example, the main control unit 1101 receives the various kinds of setting information from the user through the functional units, and stores the various kinds of setting information in the storage unit 1003. Note that, examples of the various kinds of setting information include information on the use of HOV lanes (for example, information on whether or not active use of HOV lanes is approved). When a request to provide the various kinds of setting information is received from another functional unit, the main control unit 1101 passes the information to the functional unit which has made the request.

The input reception unit 1102 receives an instruction input by the user through the input unit 1005 or the microphone 1041, and controls each of the units of the processing unit 1001 to execute processing corresponding to the request. For example, when the user makes a request to search a recommended route, the input reception unit 1102 requests the output processing unit 1103 to execute processing of displaying a map on the display 1002 so that the destination may be set.

The output processing unit 1103 receives, for example, screen information to display, such as polygon information, converts the screen information to a signal to be rendered on the display 1002, and instructs the display 1002 to render the signal.

The camera control unit 1104 controls operation of the camera 1012. For example, the camera control unit 1104 sets timings to start and end picking up an image by the camera 1012. The camera control unit 1104 also controls transmission of the picked-up image to the lane recognition unit 1105.

The lane recognition unit 1105 acquires the image picked up by the camera 1012 as image data. Then, the lane recognition unit 1105 converts the acquired image to an image for display (ground projected image). The lane recognition unit 1105 also recognizes signs and the like provided or colored on the surface of the road from the acquired image, and identifies a type of a traffic lane in which the own vehicle is traveling. For example, as described below, the lane recognition unit 1105 recognizes the presence of a sign (painted rhomboid) or the like indicating an HOV lane, and when the sign is present around the horizontal center in the image, determines that the vehicle 1300 is traveling an HOV lane. In a case where the sign is recognized not at around the horizontal center in the image, but at a position shifted to the left or the right from the around horizontal center, and is recognized on the side nearer the edge with respect to a sign of a traffic lane when viewed from around the horizontal center, the lane recognition unit 1105 determines that the vehicle 1300 is traveling a lane which is not an HOV lane and is adjacent to an HOV lane.

The qualification for traveling HOV determination unit 1106 determines whether or not the own vehicle 1300 is qualified for traveling HOV lanes. In determining the qualification, the qualification for traveling HOV determination unit 1106 determines the type and the like of the own vehicle 1300 based on the communication information flowing in an in-vehicle network of the own vehicle 1300 through the in-vehicle network communication unit 1013, and determines whether or not the own vehicle 1300 is of a type qualified for traveling HOV lanes. It should be understood, however, that the processing of determining qualification for traveling HOV lanes is not limited thereto, and the qualification for traveling HOV determination unit 1106 may determine the occupancy from load sensors (not shown) installed in seats of the vehicle or through seat belt buckle sensors, and determine whether or not the occupancy has reached an occupancy to qualify for traveling HOV lanes.

The route search unit 1107 searches for an optimal route (recommended route) which connects the user specified departure place (current position) to the user specified destination. In the route search, the route search unit 1107 searches for a route by using a route search logic such as the Dijkstra method, based on a link cost set in advance to a predetermined section (link) of the road. Note that, in the processing, the route search unit 1107 requests the above-mentioned qualification for traveling HOV determination unit 1106 to determine whether or not the own vehicle has a status to satisfy the qualification for traveling HOV lanes, and when a result of the determination is that the own vehicle has the status to satisfy the qualification for traveling, searches for a recommended route by giving priority to a route for using HOV lanes.

When the own vehicle does not have the status to satisfy the qualification for traveling, the route search unit 1107 searches for a route having the minimum link cost without considering HOV lanes. Note that, in the processing, even in a case where it is determined that the own vehicle does not have the status to satisfy the qualification for using HOV lanes, when the own vehicle is already traveling an HOV lane, the route search unit 1107 searches for a recommended route by giving priority to a route for using HOV lanes. In determining whether or not the own vehicle is already traveling an HOV lane, the route search unit 1107 refers to the HOV lane information 1228 on the link to which the present position belongs. When “YES” is registered in the attribute 1231 and the current time is included in the time of day associated with the attribute 1231 of “YES”, the route search unit 1107 determines that the own vehicle is traveling an HOV lane. On the other hand, in other cases (a case where the HOV lane information 1228 on the link to which the present position belongs does not have the attribute 1231 to which “YES” is registered, or in a case where the current time is not included in the time of day 1232 associated with the attribute 1231 to which “YES” is registered), the route search unit 1107 determines that the own vehicle is not traveling an HOV lane.

The branch guiding unit 1108 provides guidance to the driver as to the presence and position of a junction with another road, a branch to another road, and the like, by using a video or a voice. For example, the branch guiding unit 1108 causes, through the output processing unit 1103, the display 1002 to output a display notifying of an approaching junction and an approximate distance to the junction, before a position where a feeder road and a main road of an expressway or the like meet. Alternatively, the branch guiding unit 1108 notifies, at a point where a ramp road branches from a main road of an expressway, the driver of a correct traffic lane to take, with a voice through the speaker 1042.

The HOV entrance guiding unit 1109 is a functional unit which extracts link information on a link corresponding to an HOV lane and registers the link information in the guide target link table 1250. Specifically, the HOV entrance guiding unit 1109 refers to the HOV lane information 1228 of links which are within a predetermined range (for example, within 5 km) from the own vehicle position at the current time, and identifies a link corresponding to an HOV lane. Then, the HOV entrance guiding unit 1109 extracts information on the identified link and registers the extracted information in the guide target link table 1250. The HOV entrance guiding unit 1109 is also a functional unit which provides guidance as to an entrance of the HOV lane. Specifically, when the own vehicle approaches a link registered in the guide target link table 1250 enough to be within a predetermined distance (for example, 500 m), the HOV entrance guiding unit 1109 starts guidance as to the entrance of the HOV lane.

The above-mentioned functional units of the processing unit 1001 including the main control unit 1101, the input reception unit 1102, the output processing unit 1103, the camera control unit 1104, the lane recognition unit 1105, the qualification for traveling HOV determination unit 1106, the route search unit 1107, the branch guiding unit 1108, and the HOV entrance guiding unit 1109 are implemented as the CPU 1021 reads and executes predetermined programs. Therefore, the RAM 1022 stores the programs for realizing the processing of the functional units.

Note that, the above-mentioned components represent the configuration of the navigation device 1000 classified by the type of the processing mainly performed by the components for ease of understanding. Therefore, the invention of the subject application is not limited by how the components are classified or the names of the components. The configuration of the navigation device 1000 may be classified into a larger number of components based on the type of processing performed by the components. Alternatively, the configuration may be classified so that one component executes a larger number of processing.

Alternatively, the functional units may be implemented by hardware (such as ASIC or GPU). Still alternatively, the processing of each of the functional units may be executed by one piece of hardware or a plurality of pieces of hardware.

Next, operation of the target link extraction processing performed by the navigation device 1000 is described. FIG. 18 is a flow chart illustrating the target link extraction processing performed by the navigation device 1000. This flow starts when the navigation device 1000 is activated.

First, the HOV entrance guiding unit 1109 determines whether or not HOV lanes can be used (Step S1001). In other words, the HOV entrance guiding unit 1109 determines whether or not the navigation device 1000 is set to use HOV lanes (Step S1001). Specifically, the HOV entrance guiding unit 1109 acquires, from among the various kinds of setting information contained in the navigation device 1000, information on the use of HOV lanes (for example, information on whether or not the use of HOV lanes is approved is set or not) from the main control unit 1101. Then, the HOV entrance guiding unit 1109 refers to the information to determine whether or not the setting is made to use HOV lanes.

When the setting is made to use HOV lanes (Yes in Step S1001), the HOV entrance guiding unit 1109 determines whether or not the own vehicle is qualified for traveling HOV lanes (Step S1002). Specifically, the HOV entrance guiding unit 1109 requests the qualification for traveling HOV determination unit 1106 to determine whether or not the own vehicle is qualified for traveling HOV lanes. On the other hand, when the setting is not made to use HOV lanes (No in Step S1001), the HOV entrance guiding unit 1109 ends the target link extraction processing.

In Step S1002, the qualification for traveling HOV determination unit 1106 determines whether or not the own vehicle is qualified for traveling HOV lanes. Specifically, the qualification for traveling HOV determination unit 1106 identifies the type or occupancy based on the type of the own vehicle or information obtained from the load sensors or the seat belt buckle sensors. Then, the qualification for traveling HOV determination unit 1106 determines whether or not the identified type or occupancy satisfies predetermined conditions for using HOV lanes, and outputs a result of the determination to the HOV entrance guiding unit 1109.

When the own vehicle is qualified for traveling HOV lanes (Yes in Step S1002), the HOV entrance guiding unit 1109 examines, for links which are connected to the link on which the own vehicle is located and are within the predetermined range, the HOV attributes corresponding to the current time (Step S1003). Specifically, the HOV entrance guiding unit 109 identifies the link on which the own vehicle is located based on the information registered in the link table 1200. Then, the HOV entrance guiding unit 1109 examines the HOV attributes of links which are connected to the link on which the own vehicle is located and are within a range of 5 km or less from the own vehicle position, for example. At this time, the HOV entrance guiding unit 1109 examines the attributes 1231 corresponding to the current time for each of the links. On the other hand, when the own vehicle is not qualified for traveling HOV lanes (No in Step S1002), the HOV entrance guiding unit 1109 ends the target link extraction processing.

The HOV entrance guiding unit 1109 examines the attributes 1231 of the links (Step S1003), extracts a link for which “YES” is registered in the attribute 1231 corresponding to the time of day 1232 including the current time, and stores the extracted link in the the guide target link table 1250 (Step S1004).

After executing Step S1004, the HOV entrance guiding unit 1109 shifts the processing to Step S1001 (R1001). In this way, the HOV entrance guiding unit 1109 repeatedly executes the processing of Steps S1001 to S1004.

Note that, after executing Step S1004, the HOV entrance guiding unit 1109 may shift the processing to Step S1003 (R1002). In this case, for example, after executing the processing of Steps S1001 and S1002, the HOV entrance guiding unit 1109 may repeatedly execute the processing of Steps S1003 and S1004 (R1002) and shift the processing to Step S1001 at a predetermined timing (R1001). Specifically, the HOV entrance guiding unit 1109 may repeatedly execute the processing of Steps S1003 and S1004 and shift the processing to Step S1001 at timings of every 10 minutes, for example (R1001).

Next, referring to FIG. 19, HOV entrance guiding processing is described. FIG. 19 is a flow chart illustrating the HOV entrance guiding processing.

The HOV entrance guiding unit 1109 determines whether or not there is a link which is stored in the guide target link table 1250 by the target link extraction processing and which is within the predetermined range from the own vehicle position (Step S1021). Specifically, the HOV entrance guiding unit 1109 examines presence or absence of a link which is stored in the guide target link table 1250 and which is at a distance within a range of 500 m from the own vehicle position, for example. When there is such link (Yes in Step S1021), the HOV entrance guiding unit 1109 starts guidance as to an entrance of an HOV lane (S1022). Specifically, the HOV entrance guiding unit 1109 displays the required time and the distance to the HOV lane, the lane position of the HOV lane, and the like on the display 1002, and provides voice guidance through the speaker 1042.

On the other hand, when there is no link within the predetermined range from the own vehicle position (No in Step S1021), the HOV entrance guiding unit 1109 shifts the processing to Step S1033.

In Step S1023, the HOV entrance guiding unit 1109 deletes a link that has been stored in the guide target link table 1250 for a predetermined period of time from when the link is stored. Specifically, the HOV entrance guiding unit 1109 deletes, of the links stored in the guide target link table 1250, information on a link that has been stored for one hour or more from when the link is stored. Note that, such period of time for which a link is stored may be set as appropriate. Alternatively, instead of setting the predetermined period of time for which a link is stored as a requirement for deleting the link, the HOV entrance guiding unit 109 may delete a registered link when the own vehicle position moves away from the link by a predetermined distance or more, for example. The predetermined distance may also be set as appropriate. Note that, in the HOV entrance guiding processing illustrated in FIG. 19, the processing of Steps S1021 to S1023 is repeatedly executed while the target link extraction processing is executed.

Hereinabove, the flows of the target link extraction processing and the HOV entrance guiding processing have been described.

According to the navigation device of the first embodiment of the second aspect of the present invention as described above, in determining whether or not the link is an HOV lane, the HOV attribute that changes depending on the time of day is taken into consideration. As a result, according to the navigation device of the first embodiment of the second aspect of the present invention, the determination on whether or not the link is an HOV lane can be performed at higher accuracy to provide guidance as to the HOV lane.

Note that, the navigation device 1000 according to the first embodiment of the second aspect of the present invention described above identifies the HOV attributes 1231 of adjacent links corresponding to the current time, but the present invention is not limited thereto. According to a navigation device 1000 of a second embodiment of the second aspect of the present invention, the attributes 1231 of HOV lanes are identified based on expected arrival times to adjacent links. Referring to FIG. 20, operation of the navigation device 1000 according to the second embodiment of the second aspect of the present invention is described.

FIG. 20 is a flow chart illustrating target link extraction processing performed by the navigation device 1000 according to the second embodiment. In the second embodiment, processing different to that of the first embodiment is executed only in Steps S1033 and S1034. Therefore, the description of the types of processing similar to those of the first embodiment is omitted. Further, the flow illustrated in FIG. 20 starts when the navigation device 1000 is activated.

In Step S1033 of FIG. 20, when the own vehicle is qualified for traveling HOV lanes (Yes in Step S1032), the HOV entrance guiding unit 1109 examines, for links which are connected to the link on which the own vehicle is located and are within a predetermined range, the HOV attributes 1231 corresponding to the expected arrival times (Step S1033). Specifically, the HOV entrance guiding unit 1109 refers to link travel time 1225 of the link table 1200, and calculates expected arrival times to links which are connected to the link on which the own vehicle is located and are within 5 km from the own vehicle position, for example. Then, the HOV entrance guiding unit 1109 examines the attributes 1231 of the links at the calculated expected arrival times to the links. On the other hand, when the own vehicle is not qualified for traveling HOV lanes (No in Step S1002), the HOV entrance guiding unit 1109 ends the target link extraction processing.

The HOV entrance guiding unit 1109 examines the attributes 1231 of the links (Step S1033), extracts a link for which “YES” is registered in the attribute 1231 corresponding to the time of day 1232 including the expected arrival time, and stores the extracted link in the guide target link table 1250 (Step S1034).

Note that, also in the second embodiment of the second aspect of the present invention as described above, the HOV entrance guiding processing is executed as in the first embodiment of the second aspect of the present invention.

As described above, according to the second embodiment of the second aspect of the present invention, in determining whether or not the link is a target HOV lane, the expected arrival times to the links are used. The navigation device determines whether or not each link is an HOV lane based on the HOV attributes of the links identified as described above. Therefore, according to the second embodiment of the present invention, whether or not the link is an HOV lane can determined at higher accuracy to provide guidance as to the HOV lane.

Alternatively, in a modified example of the present invention, in the first embodiment or the second embodiment of the second aspect of the present invention described above, the attribute 1231 of the link may be determined again with respect to the time immediately before the guidance as to an HOV lane is provided. Specifically, when the own vehicle reaches at a point which is 1 km before the link identified as an HOV lane, the navigation device 1000 refers again to the time of day 1232 contained in the attribute 1231 of the link. Then, at the time point when the own vehicle is at 1 km before the link, the navigation device 1000 determines whether or not the attribute 1231 of the link is an HOV lane. In a case where the result of the determination is that the link is not an HOV lane, the navigation device 1000 cancels the guidance as to the entrance of the HOV. On the other hand, in a case where the link is an HOV lane, when the own vehicle position reaches at a point which is 500 m before the link, the navigation device 1000 starts the guidance as to the entrance of the HOV. Note that, in a case where a link for which the attribute 1231 is determined again is found that the link is not an HOV lane any more, the link may be deleted from the guide target link table 1250.

According to the modified example described above, for a link that is once identified as the HOV lane, it is determined again whether or not the link is a target HOV lane immediately before the link, and hence the determination can be performed at higher accuracy to provide guidance as to the entrance of the HOV lane. For example, there may be a case where the attribute of the link changes before the own vehicle reaches the link originally identified as a target HOV lane due to a traffic jam or the like. However, according to the modified example of the second aspect of the present invention, it may be reexamined whether or not the link is an HOV lane immediately before the link, and hence guidance as to the entrance of the HOV lane can be performed at higher accuracy.

### REFERENCE SIGNS LIST

100, 1000 . . . navigation device; 1, 1001 . . . processing unit; 2, 1002 . . . display; 3, 1003 . . . storage unit; 4, 1004 . . . voice input/output unit; 5, 1005 . . . input unit; 6, 1006 . . . ROM device; 7, 1007 . . . vehicle speed sensor; 8, 1008 . . . gyro sensor; 9, 1009 . . . GPS receiver; 10, 1010 . . . FM multiplex broadcasting receiver; 11, 1011 . . . beacon receiver; 12, 1012 . . . camera; 13, 1013 . . . in-vehicle network communication unit

1. A navigation device, comprising:
storage unit adapted to store lane assignment information of a traffic lane (hereinafter, referred to as “conditional lane”) that is available for passage of vehicles when a predetermined condition is satisfied; and
guiding unit adapted to provide guidance as to an entrance of the conditional lane,
wherein, when an own vehicle position is appeared to come closer to the entrance of the conditional lane, the guiding means displays an entrance guidance image for guiding the vehicle to the entrance of the conditional lane instead of a previously displayed image.

2. A navigation device according to claim 1, wherein the guiding unit is configured to:
identify a road which is within a predetermined range from the own vehicle position and is designated as the conditional lane; and
display the entrance guidance image when the own vehicle position is appeared to come closer to the identified road enough to be within a predetermined distance.

3. A navigation device according to claim 1, wherein the guiding unit displays the entrance guidance image for guiding the own vehicle to the conditional lane of a road connected along a road on which the own vehicle position is located.

4. A navigation device according to claim 1, wherein the entrance guidance image of the conditional lane is displayed in a larger size than a size of normal guidance display.

5. A guiding method employed in a navigation device which is configured to execute:
a storage step of storing lane assignment information of a traffic lane (hereinafter, referred to as “conditional lane”) that is available for passage of vehicles when a predetermined condition is satisfied; and
a guiding step of providing guidance as to an entrance of the conditional lane,
wherein, when an own vehicle position is appeared to come closer to the entrance of the conditional lane, the guiding step displays an entrance guidance image for guiding the own vehicle to the entrance of the conditional lane instead of a previously displayed image.

6. A navigation device, comprising:
storage unit adapted to store lane information containing a lane assignment time period of a traffic lane (hereinafter, referred to as “conditional lane”) that is available for passage of vehicles when a predetermined condition is satisfied; and
guiding unit adapted to provide guidance as to an entrance of the conditional lane,
wherein the guiding unit uses the lane information to identify a road to which the conditional lane is assigned at a predetermined time, and provides the guidance as to the entrance of the identified road designated as the conditional lane.

7. A navigation device according to claim 6, wherein, after identifying the road to which the conditional lane is assigned at the predetermined time, the guiding unit uses the lane information to determine whether or not the conditional lane is assigned also to the identified road, at a time when the own vehicle reaches at a point within a predetermined distance from the identified road, and stops the guidance as to the entrance of the conditional lane when the conditional lane is not assigned.

8. A navigation device according to claim 6 or 7, wherein the predetermined time is a current time or an expected arrival time at the road.

9. A guiding method employed in a navigation device which is configured to execute:
a storage step of storing lane information containing a lane assignment time period of a traffic lane (hereinafter, referred to as “conditional lane”) that is available for passage of vehicles when a predetermined condition is satisfied; and
a guiding step of providing guidance as to an entrance of the conditional lane,
wherein the guiding step comprises using the lane information to identify a road to which the conditional lane is assigned at a predetermined time, and providing the guidance as to the entrance of the identified road designated as the conditional lane.
